(19) United States
(12) Patent Application Publication
(10) Pub. No.: US 2024/0015666 A1
(43) Pub. Date: Jan. 11, 2024

(54) ANTENNA-PANEL-BASED PHR AND MPE REPORTING

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/252,107

(22) PCT Filed: Jan. 11, 2021
(86) PCT No.: PCT/CN2021/071047

§ 371 Date: May 8, 2023

(51) Int. Cl. H04W 52/36

(52) U.S. Cl. CPC H04W 52/365; H04W 52/367

(57) ABSTRACT

Certain aspects of the present disclosure provide techniques for antenna-panel-based power headroom (PHR) and maximum permissible exposure (MPE) reporting. Particular aspects provide a method performed by a user equipment (UE), which generally includes generating a frame including a PHR with one or more entries and transmitting the frame to a base station of a serving cell. In some cases, each entry of the PHR may comprise at least a first field including power headroom information and a second field including an indication of a MPE limit. Additionally, in some cases, the frame may also include information for indicating an antenna panel of the UE associated with the PHR.

### BACKGROUND

Aspects of the present disclosure relate to wireless communications, and more particularly, to techniques for antenna-panel-based power headroom report (PHR) and maximum permissible exposure (MPE) reporting.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, challenges may include any of providing power headroom information for wireless devices including multiple antenna panels. Consequently, there exists a need for further improvements in wireless communications systems to overcome various challenges.

### SUMMARY

Certain aspects can be implemented in a method for wireless communication by a user equipment (UE). The method generally includes generating a frame including a power headroom report (PHR) with one or more entries and transmitting the frame to a base station of a serving cell. In some cases, each of the one or more entries of the PHR may comprise at least a first field including power headroom information and a second field including an indication of a MPE limit. Additionally, in some cases, the frame may also include information for indicating an antenna panel of the UE associated with the PHR. The method may further include.

Certain aspects can be implemented in an apparatus for wireless communication by a user equipment (UE). The apparatus generally includes a memory comprising computer-executable instructions and one or more processors configured to execute the computer-executable instructions and cause the one or more processors to generate a frame including a power headroom report (PHR) with one or more entries and transmit the frame to a base station of a serving cell. In some cases, each of the one or more entries of the PHR may comprise at least a first field including power headroom information and a second field including an indication of a MPE limit. Additionally, in some cases, the frame may also include information for indicating an antenna panel of the UE associated with the PHR. The method may further include transmitting the frame to a base station of a serving cell.

Certain aspects can be implemented in an apparatus for wireless communication by a user equipment (UE). The apparatus generally includes means for generating a frame including a power headroom report (PHR) with one or more entries and means for transmitting the frame to a base station of a serving cell. In some cases, each of the one or more entries of the PHR may comprise at least a first field including power headroom information and a second field including an indication of a MPE limit. Additionally, in some cases, the frame may also include information for indicating an antenna panel of the UE associated with the PHR. The method may further include transmitting the frame to a base station of a serving cell.

Certain aspects can be implemented in a non-transitory computer readable medium for wireless communication by a user equipment (UE). The non-transitory computer readable medium generally includes computer-executable instructions that, when executed by one or more processors, cause the one or more processors to generate a frame including a power headroom report (PHR) with one or more entries and transmit the frame to a base station of a serving cell. In some cases, each of the one or more entries of the PHR may comprise at least a first field including power headroom information and a second field including an indication of a MPE limit. Additionally, in some cases, the frame may also include information for indicating an antenna panel of the UE associated with the PHR. The method may further include transmitting the frame to a base station of a serving cell.

Certain aspects can be implemented in a method for wireless communication by a base station (BS). The method generally includes receiving a frame including a power headroom report (PHR) with one or more entries and taking one or more actions based on the PHR. In some cases, each of the one or more entries of the PHR may comprise at least a first field including power headroom information and a second field including an indication of a MPE limit. Additionally, in some cases, the frame may also include information for indicating an antenna panel of the UE associated with the PHR. The method may further include.

Certain aspects can be implemented in an apparatus for wireless communication by a base station (BS). The apparatus generally includes a memory comprising computer-executable instructions and one or more processors configured to execute the computer-executable instructions and cause the one or more processors to receive a frame including a power headroom report (PHR) with one or more entries and take one or more actions based on the PHR. In some cases, each of the one or more entries of the PHR may comprise at least a first field including power headroom information and a second field including an indication of a MPE limit. Additionally, in some cases, the frame may also include information for indicating an antenna panel of the UE associated with the PHR. The method may further include transmitting the frame to a base station of a serving cell.

Certain aspects can be implemented in an apparatus for wireless communication by a base station (BS). The apparatus generally includes means for receiving a frame including a power headroom report (PHR) with one or more entries and means for taking one or more actions based on the PHR. In some cases, each of the one or more entries of the PHR may comprise at least a first field including power headroom information and a second field including an indication of a MPE limit. Additionally, in some cases, the frame may also include information for indicating an antenna panel of the UE associated with the PHR. The method may further include transmitting the frame to a base station of a serving cell.

Certain aspects can be implemented in a non-transitory computer readable medium for wireless communication by a base station (BS). The non-transitory computer readable medium generally includes computer-executable instructions that, when executed by one or more processors, cause the one or more processors to receive a frame including a power headroom report (PHR) with one or more entries and take one or more actions based on the PHR. In some cases, each of the one or more entries of the PHR may comprise at least a first field including power headroom information and a second field including an indication of a MPE limit. Additionally, in some cases, the frame may also include information for indicating an antenna panel of the UE associated with the PHR. The method may further include transmitting the frame to a base station of a serving cell.

The following description and the appended figures set forth certain features for purposes of illustration.

### BRIEF DESCRIPTION OF THE FIGURES

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example a base station (BS) and user equipment (UE).

FIGS. 3A-3D depict various example aspects of data structures for a wireless communication network.

FIG. 4 illustrates a single entry power headroom report (PHR) media access control control control element (MAC-CE).

FIG. 5 illustrates an example of a multiple-entry PHR MAC-CE.

FIG. 6 is a flow diagram illustrating example operations for wireless communication by a user equipment (UE), in accordance with certain aspects of the present disclosure.

FIG. 7 is a flow diagram illustrating example operations for wireless communication by a base station (BS), in accordance with certain aspects of the present disclosure.

FIG. 8 illustrates an example of a MAC-CE frame including a single-entry PHR that corresponds to only a single serving cell, in accordance with certain aspects of the present disclosure.

FIGS. 9A-9B illustrate a MAC-CE frame including a flexible entry PHR that corresponds to a single serving cell, in accordance with certain aspects of the present disclosure.

FIG. 10 illustrates a MAC-CE frame including a flexible entry PHR and a subheader with a length field, in accordance with certain aspects of the present disclosure.

FIG. 11A illustrates an example of a MAC-CE frame including a multi-entry PHR with information for indicating an antenna panel of a UE, in accordance with certain aspects of the present disclosure

FIG. 11B illustrates another example of a MAC-CE frame including a multi-entry PHR with information for indicating an antenna panel of a UE, in accordance with certain aspects of the present disclosure.

FIG. 12A illustrates an example MAC-CE frame with a multi-entry PHR that allows for more than one entry to be included for any one serving cell of multiple serving sells, in accordance with certain aspects of the present disclosure.

FIG. 12B illustrates another example MAC-CE frame with a multi-entry PHR that allows for more than one entry to be included for any one serving cell of multiple serving sells, in accordance with certain aspects of the present disclosure.

FIG. 13 illustrates an example wireless communications device configured to perform operations for the methods disclosed herein, in accordance with certain aspects of the present disclosure.

FIG. 14 illustrates an example wireless communications device configured to perform operations for the methods disclosed herein, in accordance with certain aspects of the present disclosure.

### DETAILED DESCRIPTION

Aspects of the present disclosure provide systems and methods for antenna-panel-based power headroom report (PHR) and maximum permissible exposure (MPE) reporting. Power headroom reporting generally allows a user equipment (UE) to provide a serving base station with a PHR that includes information about the difference between a maximum transmit power and an estimated transmit power needed for a scheduled uplink transmission. In some cases, the UE may include multiple antenna panels that may be used for uplink communication. Additionally, in some cases, the UE may use different transmission powers when communicating with different antenna panels. However, current PHRs may not provide a way for the UE to indicate power headroom information for individual antenna panels of the UE, which may be helpful to ensure a UE does not exceed an MPE limit when transmitting on the UL. Thus, aspects of the present disclosure provide techniques for providing power headroom information related to one or more antenna panels of a UE. Such techniques may allow a base station to determine whether a particular antenna panel of the UE has room to increase a respective transmission power.

Introduction to Wireless Communication Networks

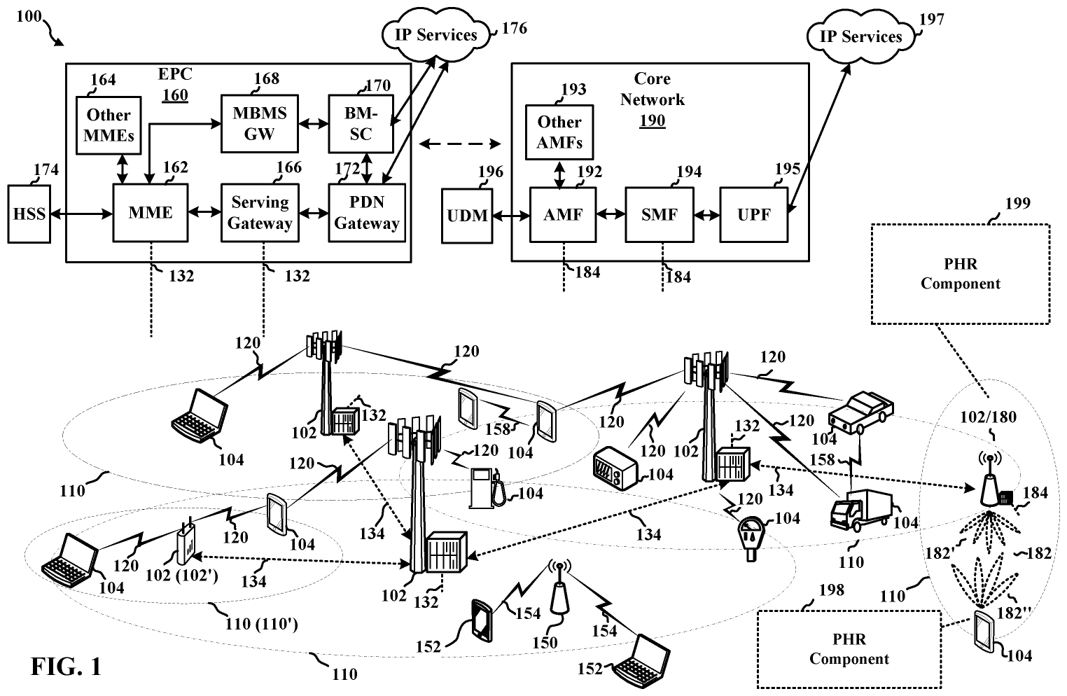

FIG. 1 depicts an example of a wireless communications system 100, in which aspects described herein may be implemented.

Generally, wireless communications system 100 includes base stations (BSs) 102, user equipments (UEs) 104, an Evolved Packet Core (EPC) 160, and core network 190 (e.g., a 5G Core (5GC)), which interoperate to provide wireless communications services.

Base stations 102 may provide an access point to the EPC 160 and/or core network 190 for a UE 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, Node B, eNB, an access point, a base transceiver station, a radio base station, a radio transceiver, or a transceiver function, or a transmit reception point (TRP) in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

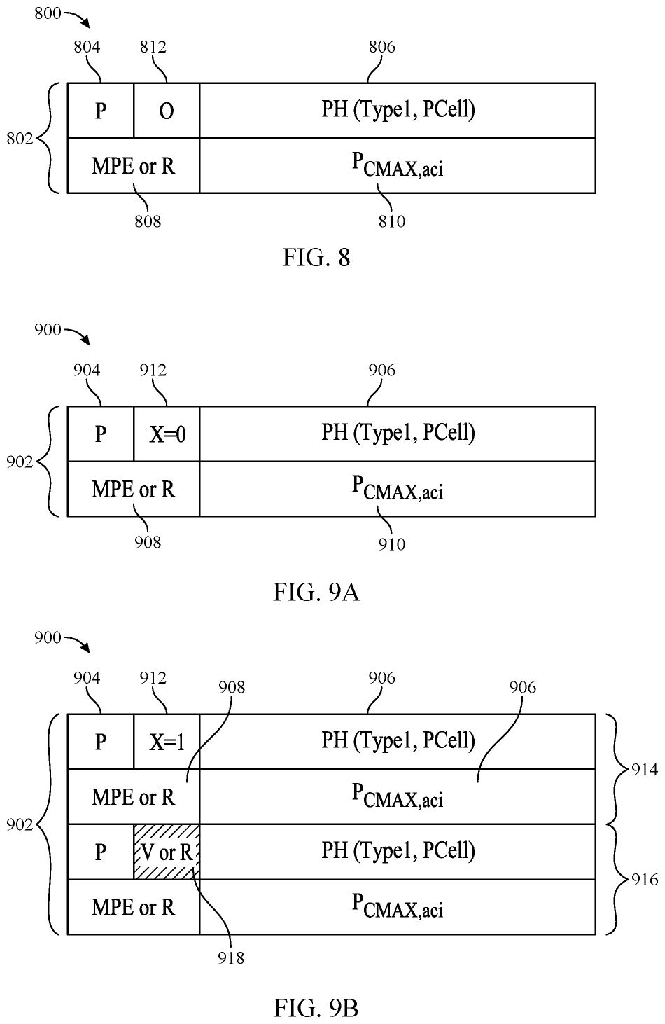

As shown base station 102 in the wireless communication network 100 includes a power headroom reporting (PHR) component 199, which may be configured to perform the operations shown in FIG. 7, as well as other operations described herein for antenna-panel-based PHR and maximum power exposure (MPE) reporting.

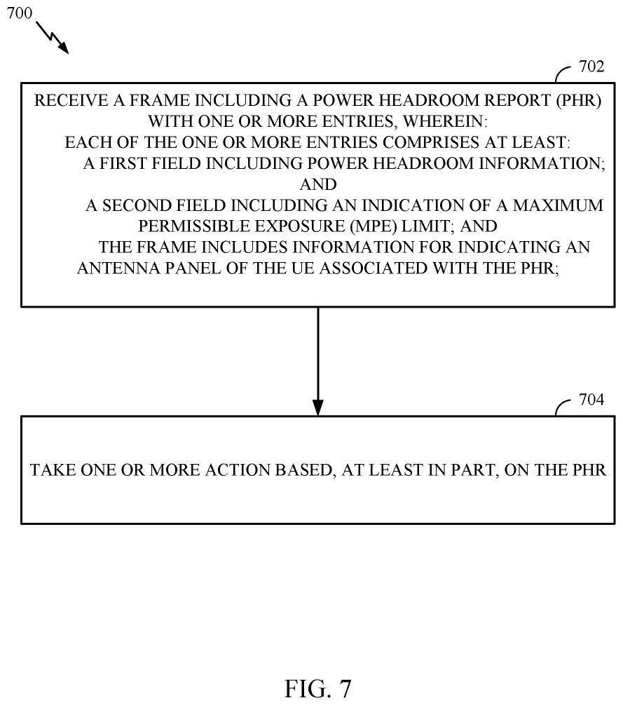

Additionally, as shown, the UE 104 may include a PHR component 198, which may be configured to perform the operations shown in FIG. 6, as well as other operations described herein for antenna-panel-based PHR and MPE reporting.

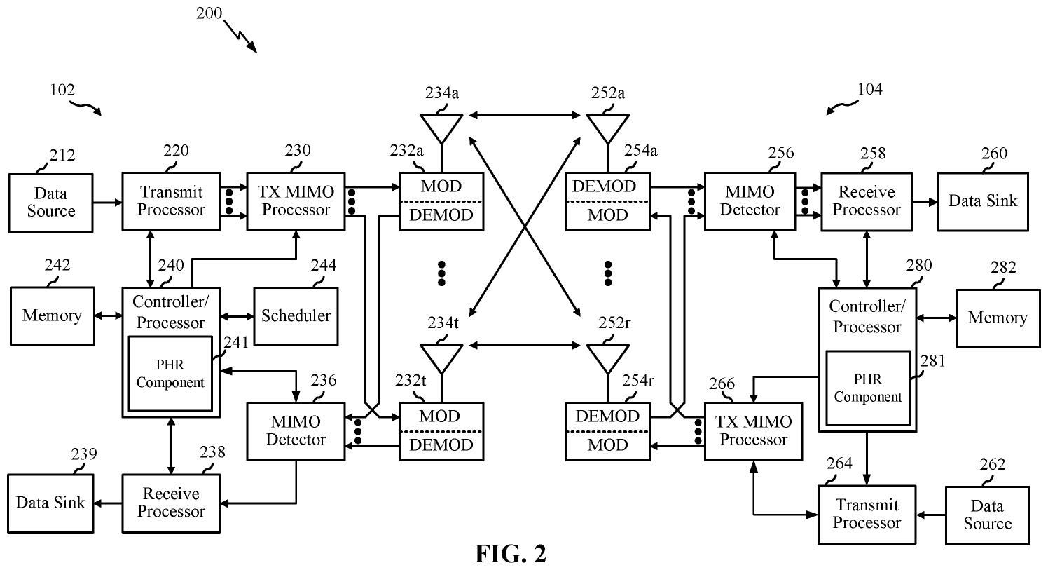

FIG. 2 depicts aspects of a base station (BS) 102 and a user equipment (UE) 104.

Generally, BS 102 includes various processors (e.g., 220, 230, 238, and 240), antennas 234a-t, transceivers 232a-t, and other aspects, which are involved in transmission of data (e.g., source data 212) and reception of data (e.g., data sink 239). For example, BS 102 may send and receive data between itself and UE 104. BS 102 includes controller/processor 240, which comprises PHR component 241. PHR component 241 may be configured to implement PHR component 199 of FIG. 1.

Generally, UE 104 includes various processors (e.g., 258, 264, 266, and 280), antennas 252a-r, transceivers 254a-r, and other aspects, involved in transmission of data (e.g., source data 262) and reception of data (e.g., data sink 260). UE 104 includes controller/processor 280, which comprises PHR component 281. PHR component 281 may be configured to implement PHR component 198 of FIG. 1.

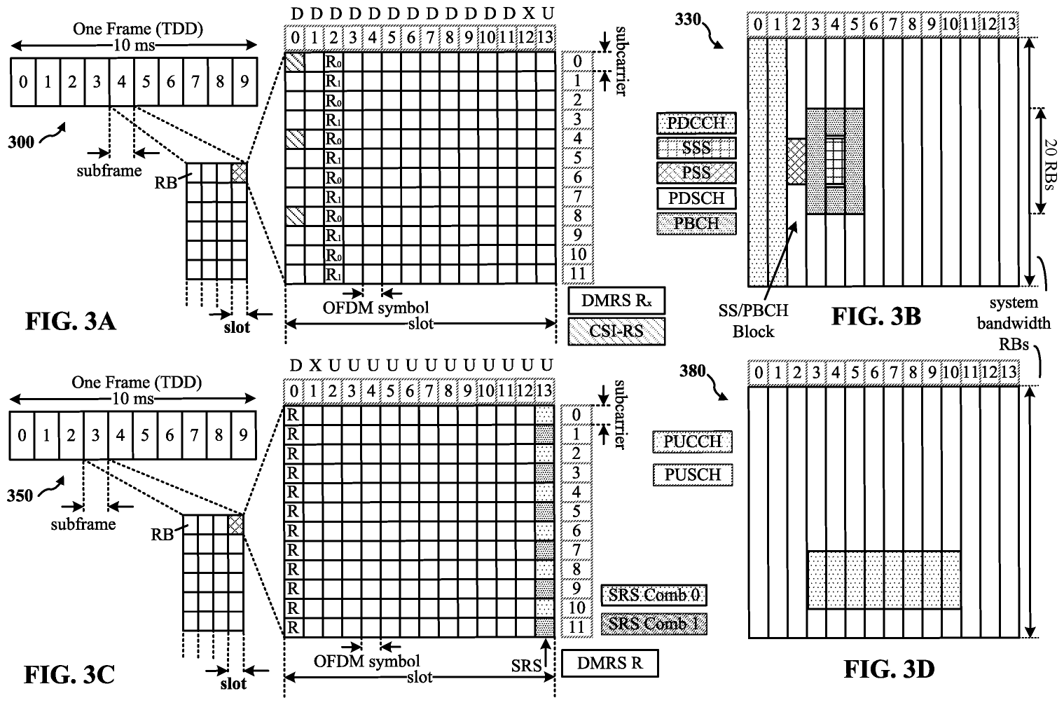

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

### Introduction to mmWave Wireless Communications

In wireless communications, an electromagnetic spectrum is often subdivided, into various classes, bands, channels, or other features. The subdivision is often provided based on wavelength and frequency, where frequency may also be referred to as a carrier, a subcarrier, a frequency channel, a tone, or a subband.

In 5G, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is sometimes referred to (interchangeably) as a “millimeter wave” (“mmW” or “mmWave”) band in documents and articles, despite being different from the extremely high frequency (EHF) band (30 GHz-300 GHz), which is identified by the International Telecommunications Union (ITU) as a “millimeter wave” band because wavelengths at these frequencies are between 1 millimeter and 10 millimeters. Radio waves in the band may be referred to as a millimeter wave. Near mmWave may extend down to a frequency of 3 GHz with a wavelength of 100 millimeters. The super high frequency (SHF) band extends between 3 GHz and 30 GHz, also referred to as centimeter wave.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

Communications using the mmWave/near mmWave radio frequency band (e.g., 3 GHz-300 GHz) may have higher path loss and a shorter range compared to lower frequency communications. Accordingly, in FIG. 1, mmWave base station 180 may utilize beamforming 182 with the UE 104 to improve path loss and range. To do so, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

### Example Power Headroom Reporting

When communicating wirelessly, wireless devices such as user equipments (UEs) and base stations (BSs) (e.g., gNB) may be limited with respect to the amount of electromagnetic radiation that may be emitted from such devices, known as a maximum permissible exposure (MPE) limit. The MPE limit represents the maximum level of electromagnetic radiation to which a person may be exposed without hazardous effects or biological changes in the eye or skin. To comply with the MPE, a limit may be placed on the transmission power of transmissions from such wireless devices, known as the maximum transmission power. In some cases, however, these wireless devices may not use all of the permissible transmission power when communicating, allowing these devices to increase their transmission power, if necessary. For example, in some cases, a serving gNB may command a UE to increase an uplink (UL) transmission power when the serving gNB has power-related information that indicates that the UE is not transmitting at a maximum transmission power. A procedure for transmitting this power-related information, may be referred to as power headroom reporting.

For example, power headroom reporting generally allows a UE to provide a serving gNB with a power headroom report (PHR) that includes information about the difference between a maximum transmit power and an estimated transmit power needed for a scheduled UL transmission. Thus, a PHR informs the network whether the UE can transmit the scheduled UL transmission at a higher transmission power or not, and in some cases indicates how much higher a transmission power the UE can implement until the maximum transmit power is reached.

In certain wireless communication systems, such as LTE, the PHR is typically 2 bytes, where one byte of data is eight bits. In 5G NR systems, the PHR may be larger than LTE implementation and include at least 3 bytes of data. For example, 5G NR defines two kinds of PHR that may be may be reported periodically or aperiodically: a single entry PHR and a multiple entry PHR.

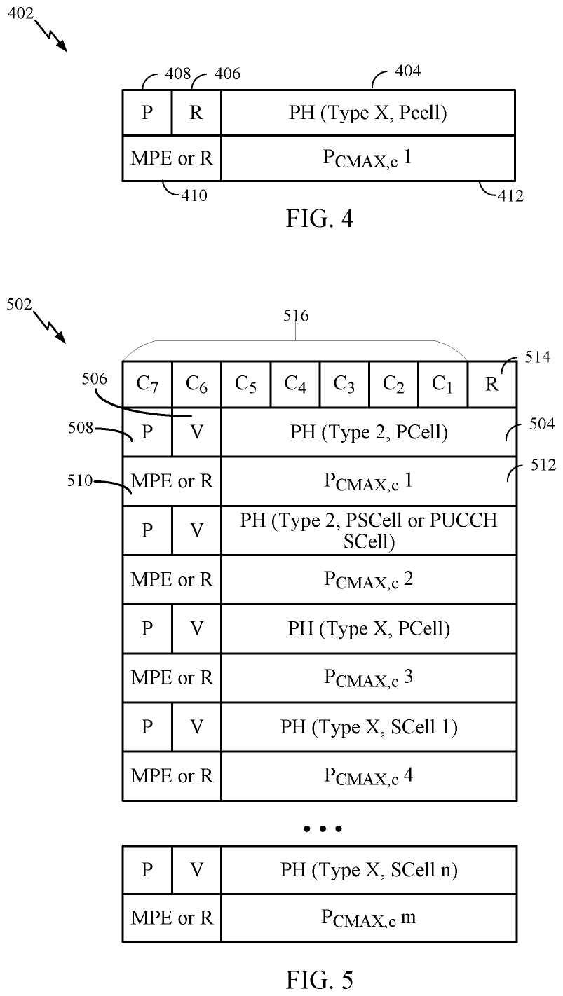

FIG. 4 illustrates a single entry PHR media access control control element (MAC-CE) 402, which is a type of downlink data structure generally sent from a BS to a UE. As shown, the single entry PHR MAC-CE 402 includes a single power headroom entry composed of a power headroom (PH) field 404, a reserved (R) field 406, a P-bit field 408, an maximum permissible exposure (MPE) or R field 410, and a maximum per-carrier transmit power (P_{CMAX}) field 412. The power headroom (PH) field 404 indicates a power headroom level associated with a serving cell. The R field 406 is reserved and set to zero by default. The P-bit field 408 indicates whether the UE applies power back off to a corresponding P_{CMAX} field 412 due to power management.

The MPE or R field 410 may include either an indication of a power back off value applied to the transmission power (e.g., to reduce the transmission power) to meet an MPE limit or reserved bits. For example, in some cases, if the higher layer parameter power management maximum power reduction (P-MPR) reporting (e.g., mpr-Reporting) is configured and if the P-bit field 408 is set to 1, the MPE or R field 410 may indicate the applied power back off is larger than a threshold P-MPR 0; otherwise the MPE or R field 410 indicates the applied power back off is less than the threshold. If mpr-Reporting is not configured, and if the P-bit field 408 is set to 1, the P-bit field 408 indicates that a corresponding P_{CMAX} field 412 would have had a different value if no power back off value (e.g., due to power management) had been applied. In some cases, the applied power back off may be indicated by an index value corresponding to a measured P-MPR level value in decibels. The P-MPR level is a maximum power reduction value applied for satisfying Specific Absorption Rate (SAR) requirements and is determined generally in consideration of the distance between the device and human body. The P_{CMAX} field 412 indicates the maximum transmission power of the UE, which may be component carrier (CC) specific.

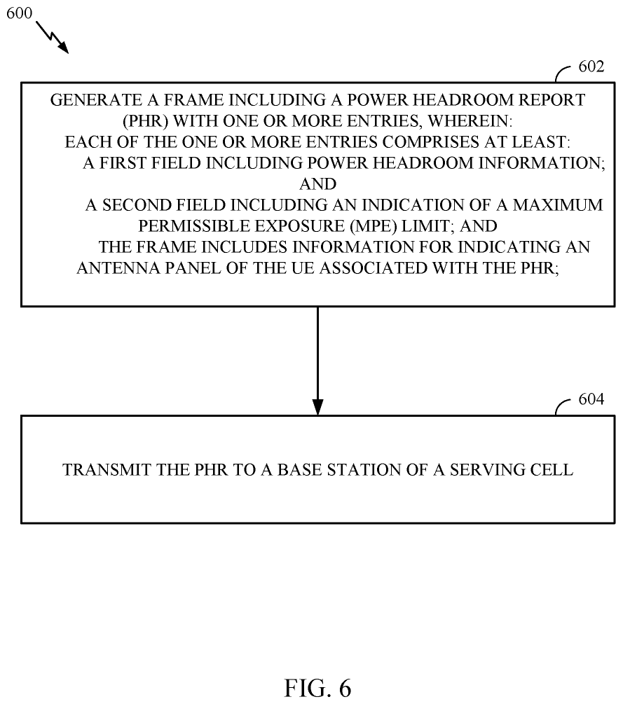

FIG. 5 illustrates one example of a multiple-entry PHR MAC-CE 502. As shown, the multiple entry PHR 502 may include multiple power headroom entries, where each entry is composed of a power headroom (PH) field 504, a V-bit field 506, a P-bit field 508, an MPE or R field 510, and a maximum per-carrier transmit power (P_{CMAX}) field 512. The V-bit field 506 indicates whether a PH value indicated in a corresponding PH field 504 is based on a real transmission (e.g., indicating a “real” power headroom) or based on a reference transmission (e.g., indicating a “virtual” power headroom). For example, the power headroom for real transmissions may be calculated based on the parameters indicated related to the real transmission, such as an indicated frequency domain resource allocation. Conversely, the power headroom for reference transmissions may be calculated based on the parameters assumed or pre-determined related to the reference transmission, such as a pre-determined reference frequency domain resource allocation.

Additionally, as shown, the multiple-entry PHR MAC-CE 502 includes a reserved (R) field 514 and a plurality of cell index (CO fields 516. Each different cell index field of the plurality of cell index fields 516 may correspond to a different serving cell and may indicate whether power headroom is being reported for that different serving cell. For example, a bit value of “1” in a cell index field indicates that a PH field 504 for the cell corresponding to the cell index of the cell index field 516 is reported in the multiple-entry PHR MAC-CE 502. If the bit value is “0,” a PH field 504 for the cell corresponding to the cell index of the cell index field 516 is not reported in the multiple-entry PHR MAC-CE 502.

### Example Antenna-Panel-Based PHR and MPE Reporting

In certain systems, such as the wireless communication network 100 of FIG. 1, a UE may be able to transmit or receive transmissions using multiple antennas, beams, and/or antenna panels (e.g., antenna element arrays). This capability may be especially useful for higher frequency transmission, such as millimeter wave transmissions. In some cases, the transmissions may be received from or transmitted to a serving base station (BS) or transmission reception point (TRP) via a Uu interface. Generally, transmissions using multiple antenna panels may allow for increased throughput (e.g., by simultaneously or concurrently transmitting/receiving data to/from the BS using the multiple antenna panels) and/or increased reliability (e.g., by sending/receiving the same information using the multiple antenna panels). Such transmissions may be referred to as multi-panel transmissions.

In some cases, a UE may use a different transmission power when communicating using different antenna panels, such as when antenna panels are of different transmit power classes. For example, the UE may use a first transmission power when communicating with a first antenna panel and use a second transmission power when communicating with a second antenna panel. Further, since transmissions from the UE are limited based on a maximum permissible exposure (MPE), as discussed above, each individual antenna panel of the UE may be subject to a same or different maximum transmission power.

However, in many cases, when communicating using a particular antenna panel, the UE may not use the maximum transmission power associated with this particular antenna panel, for example, to save power at the UE. Typically, when the UE is communicating at a transmission power less than the maximum transmission power, a serving base station may be able to command the UE to increase its transmission power based on a power headroom report (PHR) received from the UE that includes power headroom information indicating a difference between a maximum transmit power and an estimated transmit power needed for a scheduled UL transmission. However, typical PHRs may not be sufficient for multi-panel communication as these PHRs may not be capable of carrying antenna-panel-specific power-related information. Consequently, the UE may have no way of indicating power headroom and/or MPE information on an individual antenna panel basis.

Therefore, aspects of the present disclosure provide techniques for antenna-panel-based PHR and MPE reporting, allowing a UE to report power headroom information on an antenna panel basis. For example, the techniques for antenna-panel-based PHR and MPE reporting may involve generating and transmitting (e.g., to a base station of a serving cell) a frame that includes a PHR with one or more entries. Each entry in the PHR may include at least a first field including power headroom information and a second field including an indication of an MPE limit. Further, the frame may include information for indicating an antenna panel of the UE associated with the PHR. For example, the power headroom information in the first field and the indication of an MPE limit in the second field are specific to the indicated antenna panel. Accordingly, the serving base station may receive the PHR and determine that the antenna panel of the UE to which the received PHR corresponds.

FIG. 6 is a flow diagram illustrating example operations 600 for wireless communication, in accordance with certain aspects of the present disclosure. The operations 600 may be performed, for example, by a UE (e.g., such as the UE 104 in the wireless communication network 100 of FIG. 1). The operations 600 may be implemented as software components that are executed and run on one or more processors (e.g., controller/processor 280 of FIG. 2). Further, the transmission and reception of signals by the UE in operations 600 may be enabled, for example, by one or more antennas (e.g., antennas 252 of FIG. 2). In certain aspects, the transmission and/or reception of signals by the UE may be implemented via a bus interface of one or more processors (e.g., controller/processor 280 of FIG. 2) obtaining and/or outputting signals.

The operations 600 may begin, at block 602, by generating a frame including a power headroom report (PHR) with one or more entries. Each of the one or more entries of the PHR may comprise at least a first field including power headroom information and a second field including an indication of a maximum permissible exposure (MPE) limit. Additionally, the frame may also include information for indicating an antenna panel of the UE associated with the PHR.

At block 604, the UE transmits the frame to a base station of a serving cell.

FIG. 7 is a flow diagram illustrating example operations 700 for wireless communication, in accordance with certain aspects of the present disclosure. The operations 700 may be performed, for example, by a BS (e.g., such as the BS 102 in the wireless communication network 100 of FIG. 1). The operations 700 may be complementary to the operations 600 performed by the UE as describe with respect to FIG. 6. The operations 700 may be implemented as software components that are executed and run on one or more processors (e.g., controller/processor 240 of FIG. 2). Further, the transmission and reception of signals by the BS in operations 700 may be enabled, for example, by one or more antennas (e.g., antennas 234 of FIG. 2). In certain aspects, the transmission and/or reception of signals by the BS may be implemented via a bus interface of one or more processors (e.g., controller/processor 240 of FIG. 2) obtaining and/or outputting signals.

The operations 700 may begin, at block 702, by receiving a frame including a power headroom report (PHR) with one or more entries. Each of the one or more entries of the PHR may comprise at least a first field including power headroom information and a second field including an indication of a maximum permissible exposure (MPE) limit. Additionally, the frame may also include information for indicating an antenna panel of the UE associated with the PHR.

At block 704, the BS takes one or more actions based on the PHR. For example, the BS may schedule another panel for uplink transmission which is different from the one reported in the PHR with a large MPE value. In another example, the BS may schedule an uplink transmission with smaller bandwidth to the panel reported in the PHR with a median MPE value.

As noted above, aspects of the present disclosure provide techniques for antenna-panel-based PHR and MPE reporting, which may involve a UE generating at 602 and transmitting at 604 (e.g., to a base station of a serving cell of the UE) a frame that includes a PHR with one or more entries. Each entry in the PHR may include at least a first field including power headroom information and a second field including an indication of an MPE limit. In some cases, the UE may include multiple antenna panels used for communicating with base stations of one or more serving cells. Accordingly, in such cases, to individually provide power headroom information and/or MPE information associated with each antenna panel, the frame including the PHR generated at 602 may further include information for indicating an antenna panel of the UE associated with the PHR. In some cases, the PHR may correspond to only a single serving cell of the one or more serving cells of the UE. In other cases, the PHR may correspond to multiple serving cells of the one or more serving cells.

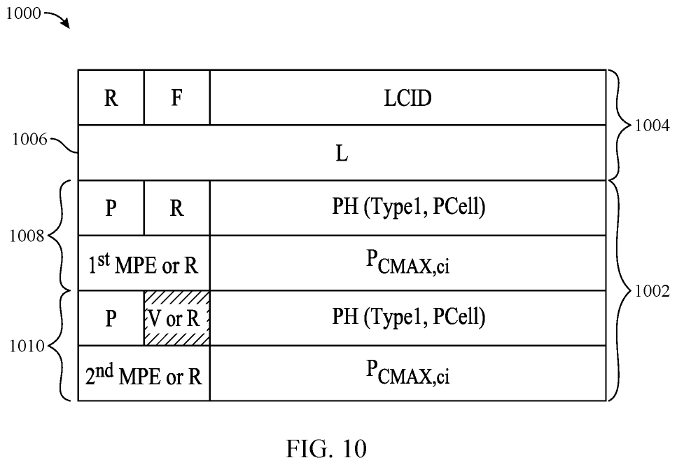

FIG. 8 illustrates an example of a MAC-CE frame 800 including a single-entry PHR 802, corresponding to only a single serving cell of the UE, and information indicating an antenna panel of the UE associated with the single-entry PHR 802, in accordance with certain aspects of the present disclosure.

In some cases, the frame generated at 602 of FIG. 6 may include the MAC-CE frame 800 shown in FIG. 8. According to aspects, the single-entry PHR 802 may comprise an entry with power headroom information corresponding to the single serving cell. As shown, the single entry PHR 802 may include a P-bit field 804, a power headroom field 806, an MPE or reserved (R) 808, and a P_{CMAX} field 810, all of which may carry similar information as described above with respect to the single entry PHR and multiple entry PHR shown FIGS. 4 and 5. For each entry, the P-bit field 804, a power headroom field 806, an MPE or reserved (R) 808, and a P_{CMAX} field 810 may be reported with panel-specific values.

According to aspects, the UE may use the single entry PHR 802 to convey power headroom information and/or MPE information corresponding to the single serving cell for one antenna panel of the UE. For example, as shown, the MAC-CE frame 800 may include an 0-bit field 812 that may be used to carry information indicating the antenna panel of the UE that is associated with the single entry PHR 802. In some cases, the information for indicating the antenna panel of the UE may comprise a panel identifier (ID) of the antenna panel of the UE to which the single entry PHR 802 corresponds. In some cases, the UE may include two antenna panels with antenna panel IDs such as antenna panel 0 and antenna panel 1 (e.g., two separate antenna panels of the UE). Accordingly, in some cases, the UE may set the 0-bit field 812 to 0 to indicate that the single entry 802 corresponds to antenna panel 0 of the UE. In other cases, the UE may set the 0-bit field 812 to 1 to indicate that the single entry 802 corresponds to antenna panel 1 of the UE.

Additionally, in some cases, the panel ID may comprise a beam group ID, a transmission configuration indicator (TCI) state pool ID, a sounding reference signal (SRS) resource ID, a SRS resource set ID, a control resource set (CORESET) pool ID, closed loop power control index. For example, antenna panels of the UE may each, in some cases, be individually associated with a different beam group ID, TCI state pool ID, SRS resource ID, CORESET pool ID, or closed loop power control index. Thus, the beam group ID, TCI state pool ID, SRS resource ID, a SRS resource set ID, CORESET pool ID, or closed loop power control index may be used to uniquely identify a panel ID of an antenna panel of the UE associated with the single entry PHR 802. For example, the UE may be configured with two SRS resource sets for non-codebook based uplink MIMO transmission, or may be configured with two SRS resource sets for codebook based uplink MIMO transmission. The UE may set the 0-bit field 812 to 1 to indicate that the single entry 802 corresponds to the transmissions associated with the 1^{st} SRS set, and set the O-bit field 812 to 1 to indicate that the single entry 802 corresponds to the transmissions associated with the 2^{st} SRS set.

### PHR with Flexibly Entry Count

In some cases, the UE may generate and transmit a MAC-CE frame including a PHR corresponding to a single serving cell with a flexible number of entries that may be used to carry power headroom information for different antenna panels of the UE. For example, in such cases, the UE may be able to indicate power headroom information corresponding to the single serving cell for one or more antenna panels (e.g., as opposed to only being able to indicate power headroom information for one antenna panel using the single entry PHR 802 of the MAC-CE frame 800).

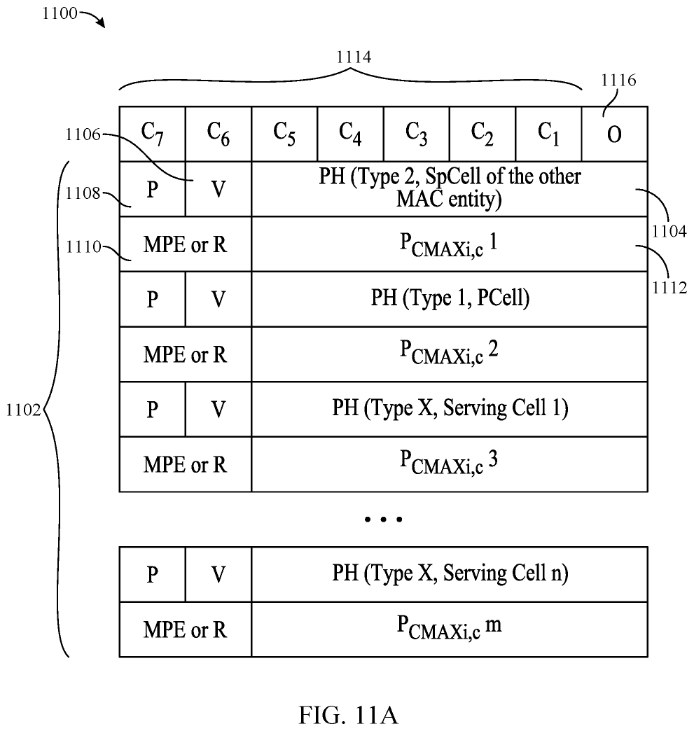

FIGS. 9A-9B illustrate a MAC-CE frame 900 including a flexible entry PHR 902, corresponding to a single serving cell of the UE, and information for indicating one or more antenna panel of the UE, in accordance with certain aspects of the present disclosure. In some cases, the frame generated at 602 of FIG. 6 may include the MAC-CE frame 900 shown in FIGS. 9A and 9B.

According to aspects, by using the MAC-CE frame 900 including the flexible entry PHR 902, the UE may be able to provide power headroom information associated with a single serving cell for one or more antenna panels. For example, when providing power headroom information for a single antenna panel, the flexible entry PHR 902 may be similar to the single-entry PHR 802 in that the flexible entry PHR 902 includes only one entry with power headroom information corresponding to the single serving cell. In other cases, when providing power headroom information for multiple (e.g., two) antenna panels, the flexible entry PHR 902 may include multiple entries, each entry carrying power headroom information associated with a corresponding antenna panel for the single serving cell.

For example, FIG. 9A illustrates the case in which the flexible entry PHR 902 includes only one entry with power headroom information corresponding to the single serving cell and associated with one antenna panel of the UE. According to aspects, each entry of the flexible entry PHR 902 illustrated in FIG. 9A (and the flexible entry PHR 902 illustrated in FIG. 9B) may include a P-bit field 904, a power headroom field 906, an MPE or reserved (R) 908, and a P_{CMAX} field 910, all of which may carry similar information as described above with respect to the single entry PHR and multiple entry PHR shown FIGS. 4 and 5.

Additionally, the MAC-CE frame 900 may include an X-bit field 912 that may be used to carry information indicating the antenna panel of the UE that is associated with the flexible entry PHR 902. In the case of a flexible entry PHR, the information for indicating the antenna panel of the UE may include at least one bit specifying a number of entries in the flexible entry PHR 902 corresponding to the single serving cell. In some cases, the at least one bit may include only a single bit that may be used to specify up to two entries. In other cases, the at least one bit may include multiple bits that may be used to specify greater than two entries.

According to aspects, specifying the number of entries in the flexible entry PHR 902 may provide an indication of which antenna panel of the UE corresponds to the flexible entry PHR 902. For example, in the case of a flexible entry PHR 902 that includes only a single entry corresponding to the single serving cell (e.g., as illustrated in FIG. 9A), the UE may set the at least one bit of the X-bit field 912 to a first value (e.g., X=0) that indicates that the flexible entry PHR 902 includes only one entry corresponding to the single serving cell and that the one entry corresponds to a default antenna panel of the UE. In other words, by setting the at least one bit of the X-bit field 912 to the first value (e.g., X=0), a base station receiving the MAC-CE frame 900 may determine that the included flexible entry PHR 902 includes only a single entry corresponding to the single serving cell and that the flexible entry PHR 902 corresponds to a default panel of the UE. In some cases, the default antenna panel of the UE may comprise an antenna panel of the UE configured for transmitting a physical uplink shared channel (PUSCH), for example, which carries the MAC-CE frame 900.

In other cases, such as illustrated in FIG. 9B, the UE may set the at least one bit of the X-bit field 912 to a second value that indicates that the flexible entry PHR 902 includes at least two entries corresponding to the single serving cell. For example, FIG. 9B illustrates an example of the flexible entry PHR 902 that includes at least two entries corresponding to the single serving cell. As illustrated, the UE may set the X-bit field 912 to a second value (e.g., X=1) to indicate that the flexible entry PHR 902 includes at least two entries corresponding to the single serving cell.

Additionally, the second value of the X-bit field 912 may provide an indication that a first entry 914 of the at least two entries correspond to a default antenna panel of the UE and that a second entry 916 of the at least two entries corresponds to another antenna panel of the UE. In other words, by setting the at least one bit of the X-bit field 912 to the second value (e.g., X=1), a base station receiving the MAC-CE frame 900 may determine that the included flexible entry PHR 902 includes at least two entries corresponding to the single serving cell and that a first entry 914 of the flexible entry PHR 902 corresponds to a default antenna panel of the UE and that a second entry 916 of the flexible entry PHR 902 corresponds to another antenna panel of the UE. It should be understood that, while the X-bit field 912 shown in FIG. 9 only includes a single bit, the X-bit field 912 may include multiple bits for indicating that the flexible entry PHR 902 includes more than two entries corresponding to the single serving cell (e.g., in cases where the UE includes more than two antenna panels).

Further, as illustrated, in the case when the flexible entry PHR 902 includes the first entry 914 corresponding to the default antenna panel of the UE and the second entry 916 corresponding to the other antenna panel of the UE, the MAC-CE frame 900 illustrated in FIG. 9B may include a V-bit field 918 that includes an indication of whether the second entry 916 corresponding to the other antenna panel of the UE includes virtual power headroom information or real power headroom information. For example, in some cases, if the UE sets the V-bit field 918 to a first value (e.g., V=1), the first value may indicate that the second entry 916 corresponding to the other antenna panel of the UE includes virtual power headroom information (e.g., power headroom information based on a reference format as opposed to real power headroom information based on a real transmission).

According to certain aspects, in some cases, instead of including an X-bit field in the MAC-CE frame with information for indicating the antenna panel of the UE (e.g., for indicating the number of entries corresponding to a single serving cell in a flexible entry PHR, which may indicate an antenna panel of the UE corresponding to each entry), the information for indicating the antenna panel of the UE may be included in a length field of a subheader of the MAC-CE frame carrying the flexible entry PHR. In this case, the length field may indicate a number of entries in the flexible PHR corresponding to the single serving cell.

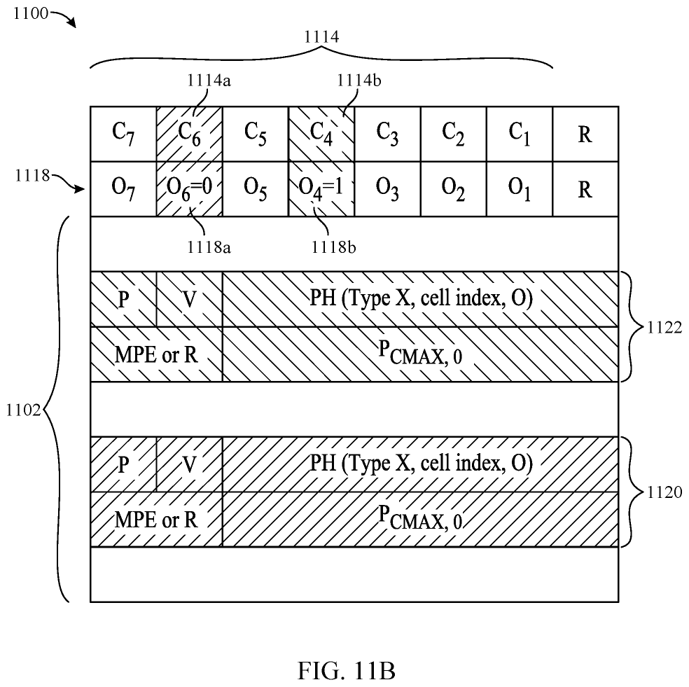

For example, FIG. 10 illustrates a MAC-CE frame 1000 including a flexible entry PHR 1002 and a subheader 1004 with a length field 1006, in accordance with certain aspects of the present disclosure. In some cases, the frame generated at 602 of FIG. 6 may include the MAC-CE frame 1000 shown in FIG. 10.

According to aspects, the UE may set a value of the length field 1006 to indicate a number of entries in the flexible PHR 1002 corresponding to a single serving cell of the UE. For example, in some cases, when a value of the length field is less than or equal to a threshold value (e.g., <2 octets), the length field 1006 may indicate that the flexible PHR 1002 includes only a first (e.g., one) entry 1008 corresponding to the single serving cell. Additionally, in such cases, the length field 1006 may indicate that the first entry 1008 in the flexible entry PHR 1002 corresponds to a default antenna panel of the UE, such as an antenna panel used for transmitting PUSCH. In other words, by setting the length field 1006 to a value of less than or equal to the threshold value (e.g., <2 octets), a base station receiving the MAC-CE frame 1000 may determine that the included flexible entry PHR 1002 includes only the first entry 1008 corresponding to the single serving cell and that the flexible entry PHR 1002 corresponds to a default panel of the UE.

In other cases, when a value of the length field 1006 is greater than the threshold value (e.g., >2 octets), the length field 1006 may indicate that the flexible entry PHR 1002 includes at least two entries corresponding to the single serving cell. Additionally, in such cases, the length field 1006 may provide an indication that a first entry 1008 of the at least two entries correspond to a default antenna panel of the UE and that a second entry 1012 of the at least two entries corresponds to another antenna panel of the UE. In other words, by setting the length field 1006 to a value of greater than the threshold value (e.g., >2 octets), a base station receiving the MAC-CE frame 1000 may determine that the included flexible entry PHR 1002 includes at least two entries and that a first entry 1008 of the flexible entry PHR 1002 corresponds to a default antenna panel of the UE and that a second entry 1010 of the flexible entry PHR 1002 corresponds to another antenna panel of the UE. It should be understood that, while the length field 1006 shown in FIG. 10 may be used to indicate that the flexible entry PHR 1002 includes two entries based on whether a value of the length field 1006 is greater than or less than a threshold, different threshold may exist that may be used to indicate that more than two entries are included within the flexible entry PHR 1002 corresponding to the single serving cell.

### PHR for Multiple Serving Cells

As noted above, in some cases, the UE may generate and transmit (e.g., at 602 and 604 illustrated in FIG. 6) a frame that includes a PHR that corresponds to multiple serving cells of the one or more serving cells of the UE. In such cases, the PHR generated at 602 may comprise a multi-entry PHR including multiple entries, each entry of the multi-entry PHR corresponding to one or more of the multiple serving cells of the UE. Additionally, as noted, the frame generated at 602 may also include information for indicating an antenna panel of the UE associated with the multi-entry PHR.

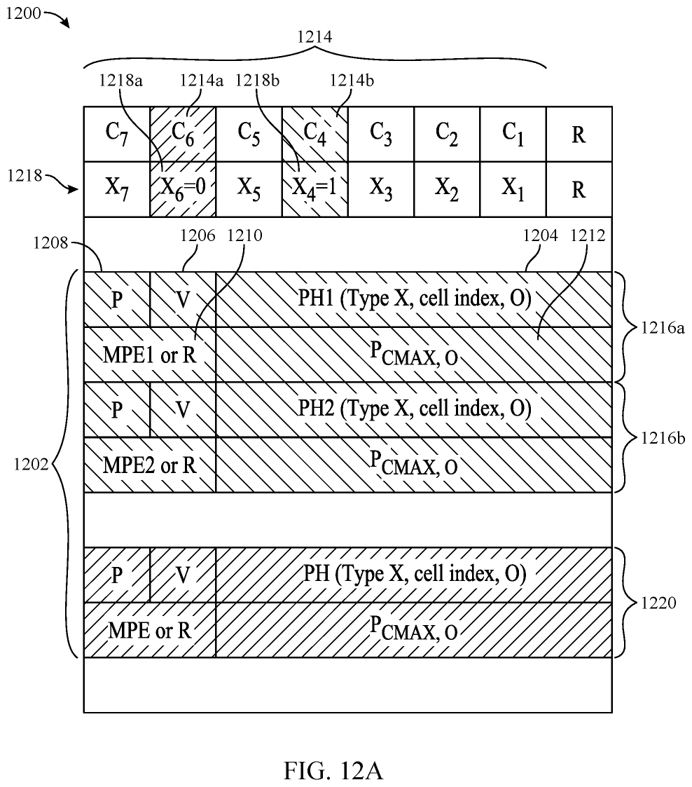

FIG. 11A illustrates an example of a MAC-CE frame 1100 including a multi-entry PHR 1102 and information for indicating an antenna panel of the UE associated with the multi-entry PHR 1102. In some cases, the frame generated at 602 of FIG. 6 may include the MAC-CE frame 1100 shown in FIG. 11A.

According to aspects, the multi-entry PHR 1102 may comprise multiple entries, each of which includes power information corresponding to one or more of the multiple serving cells of the UE. For example, as shown, each entry of the multi-entry PHR 1102 may include a power headroom field 1104, a V-bit field 1106, a P-bit field 1108, an MPE or reserved (R) field 1110, and a P_{CMAX} field 1112, all of which may carry similar information as described above with respect to the multiple entry PHR shown FIG. 5. For each entry, the P-bit field, a power headroom field, an MPE or reserved (R) field, and a P_{CMAX} field may be panel-specific. Further, as shown, the MAC-CE frame 1100 may include a plurality of cell index (CO fields 1114. Each different cell index field (CO of the plurality of cell index fields 1114 may correspond to a different serving cell of the multiple serving cells of the UE and may indicate whether power headroom is being reported for that different serving cell. For example, a bit value of “1” in a cell index field 1114 indicates that the multi-entry PHR 1102 includes an entry with power headroom information for the serving cell corresponding to that cell index field 1114. If the bit value is “0” in the cell index field 1114, that cell index field 1114 indicates that the multi-entry PHR 1102 does not includes an entry with power headroom information for the serving cell corresponding to that cell index field 1114.

Additionally, as noted, the MAC-CE frame 1100 may include information for indicating an antenna panel of the UE associated with the multi-entry PHR 1102. For example, as shown, the MAC-CE frame 1100 may also include one 0-bit field 1116 that may be used to carry information indicating the antenna panel of the UE that is associated with the multi-entry PHR 1102. In some cases, the information for indicating the antenna panel of the UE indicated in the one 0-bit field 1116 may comprise a panel identifier (ID) of the antenna panel of the UE to which all of the multiple entries in the multi-entry PHR 1102 correspond. In other words, each entry of the multiple entries in the multi-entry PHR 1102 (e.g., which may each correspond to a different serving cell as indicated by the cell index fields 1114) may correspond to the same panel of the UE as indicated by the panel ID in the one 0-bit field 1116.

For example, in some cases, the UE may include two antenna panels, such as antenna panel 0 and antenna panel 1. Accordingly, in some cases, the UE may set the one 0-bit field 1116 to 0 to indicate that the each entry in the multi-entry PHR 1102 corresponds to antenna panel 0 of the UE. In other cases, the UE may set the one 0-bit field 1116 to 1 to indicate that each entry of the multi-entry PHR 1102 corresponds to antenna panel 1 of the UE. Additionally, in some cases, the panel ID may comprise a beam group ID, a transmission configuration indicator (TCI) state pool ID, a sounding reference signal (SRS) resource ID, a SRS resource set ID, a control resource set (CORESET) pool ID, closed loop power control index, as described above in relation to FIG. 8.

In other cases, as opposed to only indicating one antenna panel of the UE (e.g., one panel ID) to which all entries in the multi-entry PHR 1102 correspond (e.g., as illustrated in FIG. 11A), the information for indicating the antenna panel of the UE in the MAC-CE frame 1100 may instead comprise a plurality of panel IDs included within a plurality of 0-bit fields 1118, as illustrated in the MAC-CE frame 1100 of FIG. 11B. In some cases, the frame generated at 602 of FIG. 6 may include the MAC-CE frame 1100 shown in FIG. 11B. Two different types of shading is shown in FIG. 11B. It should be understood that fields with similar shading each correspond to, or are associated with, each other.

In FIG. 11B, each respective panel ID of the plurality of panel IDs (e.g., indicated in the plurality of 0-bit fields 1118) may be associated with a different entry of the multiple entries in the multi-entry PHR 1102 and may specify the antenna panel of the UE for that different entry. In other words, as noted above, each entry in the multi-entry PHR 1102 may correspond to a different serving cell as indicated by a corresponding cell index field 1114. Further, each entry in the multi-entry PHR 1102 and each corresponding cell index field 1114 may have a corresponding 0-bit field of the plurality of 0-bit fields 1118 which includes a panel ID specifying the antenna panel of the UE corresponding to that entry and corresponding cell index.

Thus, by using the MAC-CE frame 1100 and multi-entry PHR 1102 illustrated in FIG. 11B, the UE may specify the antenna panel (e.g., a same antenna panel or a different antenna panel) of the UE for each individual entry in the multi-entry PHR 1102 corresponding to different serving cells (e.g., cell index fields 1114). For example, in some cases, the UE may include two antenna panels with antenna panel IDs such as antenna panel 0 and antenna panel 1. Accordingly, as illustrated in FIG. 11B, in some cases, the UE may set a first 0-bit field 1118a to 0 to indicate that a first cell index field 1114a and a first entry 1120 in the multi-entry PHR 1102 corresponds to antenna panel 0 of the UE. Similarly, the UE may also set a second 0-bit field 1118b to 1 to indicate that a second cell index field 1114b and a second entry 1122 in the multi-entry PHR 1102 corresponds to antenna panel 1 of the UE.

In some cases, the UE may generate (e.g., at 602 of FIG. 6) and transmit at (e.g., at 604 of FIG. 6) a MAC-CE frame with multi-entry PHR that allows for multiple entries for a serving cell of the UE. For example, in some cases, the multi-entry PHR may include at least two entries for a first serving cell of the UE, allowing the UE to specify power headroom information for the first serving cell for different antenna panels of the UE. Moreover, the multi-entry PHR may also include multiple entries for one or more additional serving cells, allowing the UE to specify power headroom information for the one or more other serving cells for different antenna panels.

### Multi-Entry/Multi-Serving Cell PHR

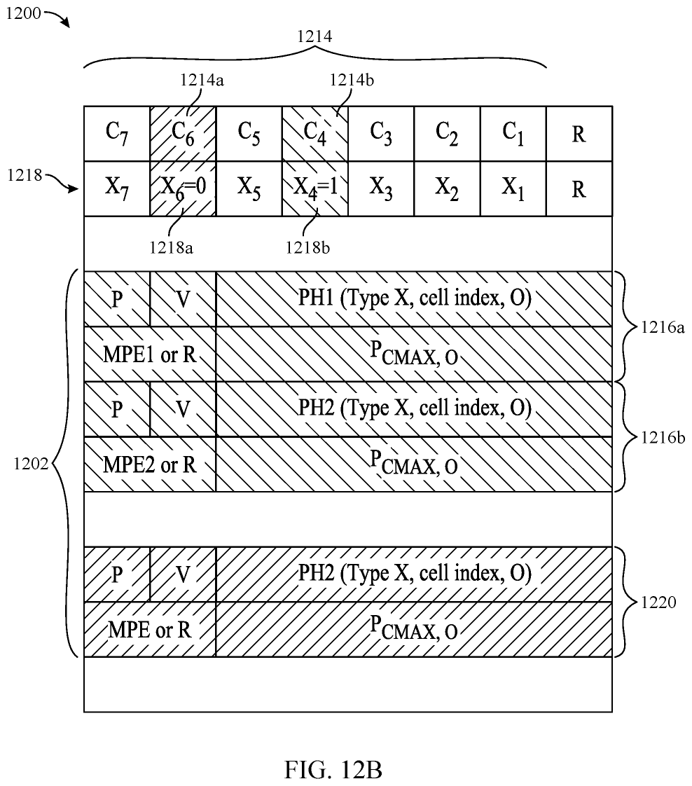

FIG. 12A illustrates an example MAC-CE frame 1200 with a multi-entry PHR 1202 that allows for more than one entry to be included for any one serving cell of the multiple serving sells of the UE, in accordance with certain aspects presented herein. In some cases, the frame generated at 602 of FIG. 6 may include the MAC-CE frame 1200 shown in FIG. 12A. Two different types of shading is shown in FIG. 12A. It should be understood that fields with similar shading each correspond to, or are associated with, each other.

For example, as shown, each entry of the multi-entry PHR 1202 may include a power headroom field 1204, a V-bit field 1206, a P-bit field 1208, an MPE or reserved (R) 1210, and a P_{CMAX} field 1212, all of which may carry similar information as described above with respect to the multiple entry PHR shown in FIG. 5. Further, as shown, the MAC-CE frame 1200 may include a plurality of cell index (CO fields 1214. Each different cell index field (CO of the plurality of cell index fields 1214 may correspond to a different serving cell of the multiple serving cells of the UE and may indicate whether power headroom is being reported for that different serving cell. For example, a bit value of ‘1’ in a cell index field 1214 indicates that the multi-entry PHR 1202 includes an entry with power headroom information for the serving cell corresponding to that cell index field 1214. If the bit value is ‘0’ in the cell index field 1214, that cell index field 1214 indicates that the multi-entry PHR 1202 does not includes an entry with power headroom information for the serving cell corresponding to that cell index field 1214.

Additionally, as noted, the MAC-CE frame 1200 may include information for indicating an antenna panel of the UE associated with the multi-entry PHR 1202. For example, as illustrated in FIG. 12A, the information for indicating the antenna panel of the UE associated with the multi-entry PHR 1202 may include a plurality of X-bit fields 1218 in the MAC-CE frame 1200. The plurality of X-bit fields 1218 may, collectively, include a plurality of bits and each bit of the plurality of bits (and its respective X-bit field 1218) corresponds to a different serving cell of the multiple serving cells of the UE. Further, each bit of the plurality of bits may specify a number of entries of the multiple entries in the multi-entry PHR 1202 that correspond to its corresponding serving cell of the multiple serving cells.

In other words, each X-bit field of the plurality of X-bit fields 1218 may individually correspond to one different serving cell of the multiple serving cells of the UE. For example, as illustrated, a first X-bit field 1218a may correspond with a first cell index field 1214a (and a first serving cell corresponding to the first cell index field 1214a). Further, as shown, a second X-bit field 1218b may correspond with a second cell index field 1214b (and a second serving cell corresponding to the second cell index field 1214b). According to aspects, a first bit in the first X-bit field 1218a may indicate the number of entries of the multiple entries in the multi-entry PHR 1202 that correspond to the first serving cell. Likewise, a second bit in the second X-bit field 1218b may indicate the number of entries of the multiple entries in the multi-entry PHR 1202 that correspond to the second serving cell.

According to aspects, specifying the number of entries of the multiple entries in the multi-entry PHR 1202 that correspond to a particular serving cell may provide an indication of which antenna panel(s) of the UE correspond to the entries for that particular serving cell. For example, in some cases, the UE may set the first bit of the first X-bit field 1118a to a first value (e.g., X=0) that indicates that the multi-entry PHR 1202 includes only one entry 1220 corresponding to the first serving cell (e.g., and first cell index field 1214a) and that the one entry 1220 corresponds to a default antenna panel of the UE. In other words, by setting the first bit of the first X-bit field 1118a to the first value (e.g., X=0), a base station receiving the MAC-CE frame 1200 may determine that the included multi-entry PHR 1202 includes only one entry 1220 corresponding to the first serving cell (e.g., and first cell index field 1214a) and that the one entry 1220 in the multi-entry PHR 1202 for the first serving cell corresponds to a default panel of the UE, such as an antenna panel being scheduled with a PUSCH. As shown, each of the one entry 1220, the first X-bit field 1118a, and the first cell index field 1214a have similar shading, indicating that each of these fields correspond to, or are associated with, each other.

In other cases, the UE may set the second bit of the second X-bit field 1218b to a second value (e.g., X=1) that indicates that the multi-entry PHR 1202 includes at least two entries 1216a and 1216b corresponding to the second serving cell (e.g., and second cell index field 1214b). Additionally, the second value of the second bit may indicate that a first entry 1216a of the at least two entries corresponds to a default antenna panel of the UE used for transmitting PUSCH and that a second entry 1216b of the at least two entries corresponds to another (e.g., a second) antenna panel of the UE. In other words, by setting the second bit of the second X-bit field 1218b to the second value (e.g., X=1), a base station receiving the MAC-CE frame 1200 may determine that the included multi-entry PHR 1202 includes at least two entries 1216a and 1216b corresponding to the second serving cell (e.g., and second cell index field 1214b). Additionally, based on the second value of the second X-bit field, the base station receiving the MAC-CE frame 1200 may determine that a first entry 1216a of the at least two entries corresponds to a default antenna panel of the UE and that a second entry 1216b of the at least two entries corresponds to another (e.g., a second) antenna panel of the UE. As shown, each of the two entries 1216a and 1216b, the second X-bit field 1118b, and the second cell index field 1214b have similar shading, indicating that each of these fields correspond to, or are associated with, each other.

According to aspects, while the MAC-CE frame 1200 of FIG. 12a may allow a UE to report multiple entries corresponding to a single serving cell for multiple antenna panels, the MAC-CE frame 1200 may be limited in that the UE may not be able to report an entry for that serving cell for only the second antenna panel of the UE. That is, as can be seen in FIG. 12a, the MAC-CE frame 1200 may only allow the UE to report one entry for a serving cell for a default panel of the UE or at least two entries for the serving cell for the default panel of the UE and the second antenna panel of the UE.

Thus, FIG. 12B illustrates an example of the MAC-CE frame 1200 that provides the UE with flexibility to report one or more entries in the multi-entry PHR 1202 for a serving cell for either a default antenna panel of the UE, a second antenna panel of the UE, or both the default antenna panel of the UE and the second antenna panel of the UE, in accordance with certain aspects presented herein. In some cases, the frame generated at 602 of FIG. 6 may include the MAC-CE frame 1200 shown in FIG. 12B. Two different types of shading is shown in FIG. 12B. It should be understood that fields with similar shading each correspond to, or are associated with, each other.

As noted above, the MAC-CE frame 1200 may include information for indicating an antenna panel of the UE associated with the multi-entry PHR 1202. According to aspects, the information for indicating an antenna panel of the UE associated with the multi-entry PHR 1202 may, in this case, include a first plurality of bits and a second plurality of bits. In some cases, the first plurality of bits may be included in, for example, the plurality of cell index fields 1214. Additionally, in some cases, the second plurality of bits may be included in, for example, the plurality of X-bit fields 1218.

According to aspects, the UE may be able to report one or more entries in the multi-entry PHR 1202 for a serving cell for either a default antenna panel of the UE, a second antenna panel of the UE, or both the default antenna panel of the UE and the second antenna panel of the UE by using different combinations of values of bits in the first plurality of bits and bits in the second plurality of bits. For example, as shown in FIG. 12B, the first cell index field 1214a may a first bit of the first plurality of bits associated with a first serving cell. Likewise, the first X-bit field 1218a may include a first bit of the second plurality of bits associated with a first serving cell. Accordingly, in some cases, a combination of a value of the first bit first X-bit field 1218a and a value of the first bit of the first cell index field 1214a may indicate whether the multi-entry PHR 1202 includes at least two entries corresponding to the first serving cell, only one entry corresponding to the first serving cell, or no entries corresponding to the first serving cell. Additionally, if the multi-entry PHR 1202 includes at least two entries corresponding to the first serving cell, the combination may indicate indicates a different antenna panel of the UE corresponding to each entry of the at least two entries. Similarly, if the multi-entry PHR 1202 includes only one entry corresponding to the first serving cell, the combination may indicate that a first antenna panel of the UE corresponds to the one entry or a second antenna panel of the UE corresponds to the one entry.

For example, as illustrated in FIG. 12B, the UE may set a value of the first bit of the first cell index field 1214a to ‘0’ and a value of the first bit of the first X-bit field 1218a to ‘1’, which may indicate that the multi-entry PHR 1202 includes only one entry 1220 for the first serving cell and that this one entry 1220 corresponds to a second antenna panel of the UE. Additionally, in some cases, the UE may set a value of the first bit of the first cell index field 1214a to ‘1’ and a value of the first bit of the first X-bit field 1218a to ‘0’, which may indicate that the multi-entry PHR 1202 includes only one entry 1220 for the first serving cell and that this one entry 1220 corresponds to a first antenna panel of the UE, which may comprise a default antenna panel used for transmitting PUSCH.

In another case illustrated in FIG. 12B, the UE may set a value of a second bit of a second cell index field 1214b (e.g., associated with a second serving cell) to ‘1’ and a value of a second bit of a second X-bit field 1218b (e.g., associated with the second serving cell) to ‘1’, which may indicate that the multi-entry PHR 1202 includes two entries for the second serving cell. Additionally, the combination of the value of the second bit of the second cell index field 1214b and the value of the second bit of the second X-bit field 1218b may indicate that a first entry 1216a of the two entries corresponds to a first antenna panel of the UE and that a second entry 1216b of the two entries correspond to a second antenna panel of the UE.

Additionally, in some cases, the UE may set a value of the first bit of the first cell index field 1214a to ‘0’ and a value of the first bit of the first X-bit field 1218a to ‘0’, which may indicate that the multi-entry PHR 1202 does not include any entries for the first serving cell.

It should be understood that, while each cell index field of the plurality of cell index fields 1214 and each X-bit field of the plurality of X-bit fields 1218 are illustrated as only including a single bit, each of the cell index fields of the plurality of cell index fields 1214 may include more than one bit and each of the X-bit fields of the plurality of X-bit fields 1218 may include more than one bit. According to aspects, by each including more than one bit, different combinations of the multiple bits of the first cell index field 1214a and the multiple bits of the first X-bit field 1218a may be used to indicate that the multi-entry PHR 1202 includes more than two entries corresponding to the first serving cell (e.g., in the case where the UE includes more than two antenna panels).

As noted above, at 604 if FIG. 6, the UE may transmit a frame, including a PHR, to a base station of a serving cell. The frame transmitted at 604 may include any one of the MAC-CE frames illustrated in FIG. 8, 9A, 9B, 10, 11A, 11B, 12A, or 12B. Thereafter, as illustrated in FIG. 7, the base station may receive the frame at 702 and may take one or more actions based, at least in part, on the PHR included in the frame. For example, in some cases, the base station may compare a signal to interference plus noise (SINR) associated with a signal received from a first antenna panel of the UE with a desired SINR target value. When the SINR of the signal received from the antenna panel of the UE is below the SINR target value, the base station may determine that an uplink transmission power of the antenna panel may need to be increased to meet the SINR target value. In response to this determination to increase the transmission power, the base station may determine based on the PHR in the frame whether the first antenna panel of the UE has additional transmission power (e.g., before reaching a maximum transmission power associated with the antenna panel) that may be used. When the first antenna panel has additional transmission power that may be used, the base station may transmit signaling to the UE instructing the UE to increase the transmission power for uplink transmissions performed by the first antenna panel. In some cases, when the first antenna panel does not have additional transmission power available, the base station may transmit signaling to the UE, instructing the UE to use another antenna panel for uplink transmissions.

### Example Wireless Communication Devices

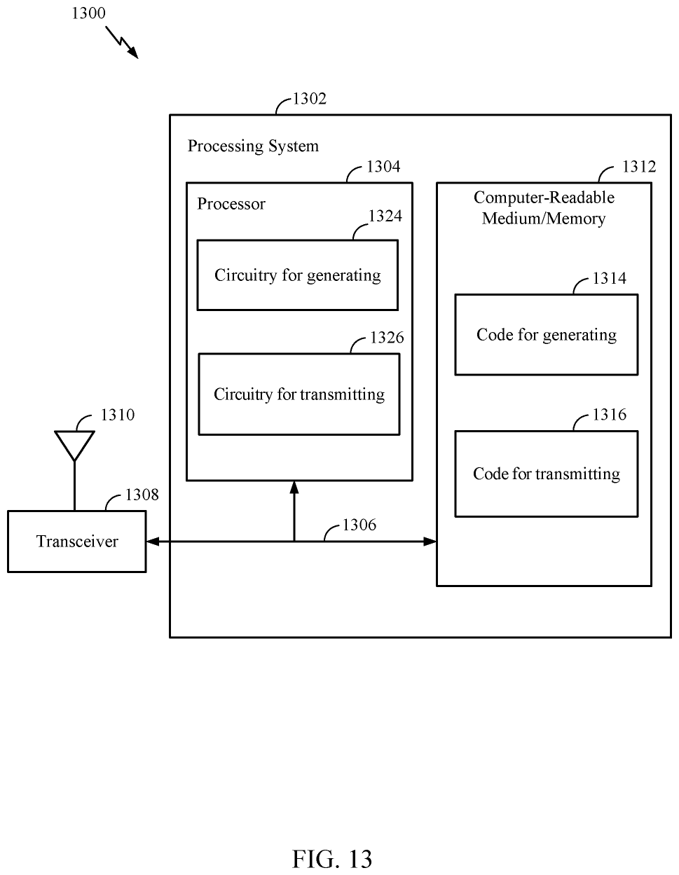

FIG. 13 illustrates a communications device 1300 that may include various components (e.g., corresponding to means-plus-function components) configured to perform operations for the techniques disclosed herein, such as the operations illustrated in FIG. 6.

Communications device 1300 includes a processing system 1302 coupled to a transceiver 1308 (e.g., a transmitter and/or a receiver). Transceiver 1308 is configured to transmit and receive signals for the communications device 1300 via an antenna 1310, such as the various signals as described herein. Processing system 1302 may be configured to perform processing functions for communications device 1300, including processing signals received and/or to be transmitted by communications device 1300.

Processing system 1302 includes a processor 1304 coupled to a computer-readable medium/memory 1312 via a bus 1306. In certain aspects, computer-readable medium/memory 1312 is configured to store instructions (e.g., computer-executable code) that when executed by processor 1304, cause processor 1304 to perform the operations illustrated in FIG. 6 or other operations for performing the various techniques discussed herein for antenna-panel-based PHR and MPE reporting. In some cases, the processor 1304 can include one or more components of UE 104 with reference to FIG. 2 such as, for example, controller/processor 280 (including the TCI state application time component 281), transmit processor 264, receive processor 258, and/or the like. Additionally, in some cases, the computer-readable medium/memory 1312 can include one or more components of UE 104 with reference to FIG. 2 such as, for example, memory 282 and/or the like.

In certain aspects, computer-readable medium/memory 1312 stores code 1314 for generating and code 1316 for transmitting.

In some cases, code 1314 for generating may include code for generating a frame including a power headroom report (PHR) with one or more entries. In some cases, each of the one or more entries of the PHR may comprise at least a first field including power headroom information and a second field including an indication of a MPE limit. Additionally, in some cases, the frame may also include information for indicating an antenna panel of the UE associated with the PHR.

In some cases, code 1316 for transmitting may include code for transmitting the frame to a base station of a serving cell.

In certain aspects, processor 1304 has circuitry configured to implement the code stored in the computer-readable medium/memory 1312. For example, processor 1304 includes circuitry 1324 for generating and circuitry 1326 for transmitting.

In some cases, circuitry 1324 for generating may include circuitry for generating a frame including a power headroom report (PHR) with one or more entries. In some cases, each of the one or more entries of the PHR may comprise at least a first field including power headroom information and a second field including an indication of a MPE limit. Additionally, in some cases, the frame may also include information for indicating an antenna panel of the UE associated with the PHR.

In some cases, circuitry 1326 for transmitting may include circuitry for transmitting the frame to a base station of a serving cell.

In some examples, means for generating may include a processing system, which may include one or more processors, such as the receive processor 258, the transmit processor 264, the TX MIMO processor 266, and/or the controller/processor 280 of the UE 104 illustrated in FIG. 2 and/or the processing system 1302 of the communication device 1300 in FIG. 13 (e.g., including circuitry 1324 for generating).

In some examples, means for transmitting (or means for outputting for transmission) may include the transmitter unit 254 and/or antenna(s) 252 of the UE 104 illustrated in FIG. 2 and/or circuitry 1326 for transmitting of the communication device 1300 in FIG. 13.

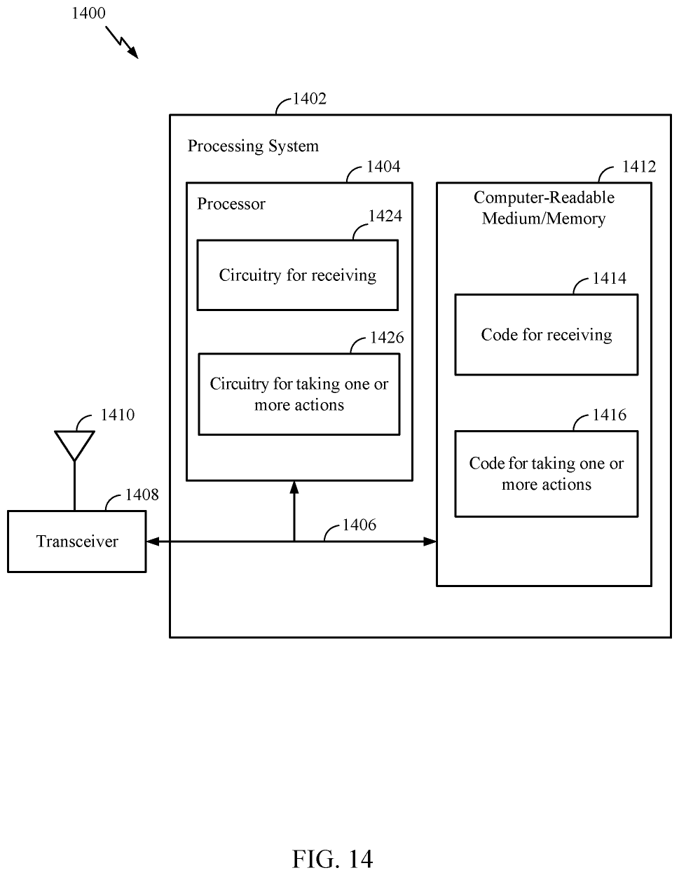

FIG. 14 illustrates a communications device 1400 that may include various components (e.g., corresponding to means-plus-function components) configured to perform operations for the techniques disclosed herein, such as the operations illustrated in FIG. 7.

Communications device 1400 includes a processing system 1402 coupled to a transceiver 1408 (e.g., a transmitter and/or a receiver). Transceiver 1408 is configured to transmit and receive signals for the communications device 1400 via an antenna 1410, such as the various signals as described herein. Processing system 1402 may be configured to perform processing functions for communications device 1400, including processing signals received and/or to be transmitted by communications device 1400.

Processing system 1402 includes a processor 1404 coupled to a computer-readable medium/memory 1412 via a bus 1406. In certain aspects, computer-readable medium/memory 1412 is configured to store instructions (e.g., computer-executable code) that when executed by processor 1404, cause processor 1404 to perform the operations illustrated in FIG. 7, or other operations for performing the various techniques discussed herein for antenna-panel-based PHR and MPE reporting. In some cases, the processor 1404 can include one or more components of BS 102 with reference to FIG. 2 such as, for example, controller/processor 240 (including the TCI state application time component 241), transmit processor 220, receive processor 238, and/or the like. Additionally, in some cases, the computer-readable medium/memory 1412 can include one or more components of BS 102 with reference to FIG. 2 such as, for example, memory 242 and/or the like.

In certain aspects, computer-readable medium/memory 1412 stores code 1414 for receiving code 1416 for taking one or more actions.

In some cases, code 1414 for receiving may include code for receiving a frame including a power headroom report (PHR) with one or more entries. In some cases, each of the one or more entries of the PHR may comprise at least a first field including power headroom information and a second field including an indication of a MPE limit. Additionally, in some cases, the frame may also include information for indicating an antenna panel of the UE associated with the PHR.

In some cases, code 1416 for taking one or more actions may include code for taking one or more actions based on the PHR.

In certain aspects, processor 1404 has circuitry configured to implement the code stored in the computer-readable medium/memory 1412. For example, processor 1404 includes circuitry 1424 for receiving and circuitry 1426 for taking one or more actions.

In some cases, circuitry 1424 for receiving may include circuitry for receiving a frame including a power headroom report (PHR) with one or more entries. In some cases, each of the one or more entries of the PHR may comprise at least a first field including power headroom information and a second field including an indication of a MPE limit. Additionally, in some cases, the frame may also include information for indicating an antenna panel of the UE associated with the PHR.

In some cases, circuitry 1426 for taking one or more actions may include circuitry for taking one or more actions based on the PHR.

In some examples, means for receiving (or means for obtaining) may include a receiver and/or an antenna(s) 234 of the BS 102 illustrated in FIG. 2 and/or circuitry 1424 for receiving of the communication device 1400 in FIG. 14.

In some examples, means for taking one or more actions may include a processing system, which may include one or more processors, such as the transmit processor 220, the TX MIMO processor 230, the receive processor 238, and/or the controller/processor 240 of the BS 102 illustrated in FIG. 2 and/or the processing system 1402 of the communication device 1400 in FIG. 14.

### Example Clauses

Implementation examples are described in the following numbered clauses:

Clause 1: A method for wireless communication by a user equipment (UE), comprising: generating a frame including a power headroom report (PHR) with one or more entries, wherein: each of the one or more entries comprises at least: a first field including power headroom information; and a second field including an indication of a maximum permissible exposure (MPE) limit; and the frame includes information for indicating an antenna panel of the UE associated with the PHR; and transmitting the frame to a base station of a serving cell.

Clause 2: The method of Clause 1, wherein the PHR corresponds to a single serving cell of one or more serving cells of the UE.

Clause 3: The method of Clause 2, wherein: the PHR includes only one entry corresponding to the single serving cell and the information for indicating the antenna panel of the UE comprises a panel identifier (ID) of the antenna panel of the UE to which the one entry in the PHR corresponds.

Clause 4: The method of Clause 3, wherein the panel ID comprises one or more of: a beam group ID; a transmission configuration indicator (TCI) state pool ID; a sounding reference signal (SRS) resource ID; a control resource set (CORESET) pool ID; or closed loop power control index.

Clause 5: The method of Clause 2, wherein the information for indicating an antenna panel of the UE includes at least one bit specifying a number of entries in the PHR corresponding to the single serving cell.

Clause 6: The method of Clause 5, wherein: a first value of the at least one bit indicates that the PHR includes only one entry corresponding to the single serving cell and that the one entry corresponds to a default antenna panel of the UE; and a second value of the at least one bit indicates that: the PHR includes at least two entries corresponding to the single serving cell; a first entry of the at least two entries correspond to a default antenna panel of the UE; and a second entry of the at least two entries corresponds to another antenna panel of the UE.

Clause 7: The method of Clause 6, wherein the default antenna panel of the UE is an antenna panel of the UE used for transmitting a physical uplink shared channel (PUSCH) media access control element (MAC-CE).

Clause 8: The method of any of Clauses 6-7, wherein the PHR further includes an indication of whether the second entry corresponding to the other antenna panel of the UE includes virtual power headroom information or real power headroom information.

Clause 9: The method of Clause 2, wherein the frame comprises a media access control element (MAC-CE) and the information for indicating the antenna panel of the UE is included in a length field of a subheader of the MAC-CE.

Clause 10: The method of Clause 9, wherein the length field indicates a number of entries in the PHR corresponding to the single serving cell.

Clause 11: The method of Clause 10, wherein: when a value of the length field is less than or equal to a threshold value, the length field indicates that the PHR includes only one entry corresponding to the single serving cell and that the one entry corresponds an antenna panel of the UE used for transmitting a physical uplink shared channel (PUSCH); and when the value of the length field is greater than the threshold value, the length field indicates that: the PHR includes at least two entries corresponding to the single serving cell; a first entry of the at least two entries correspond to the antenna panel of the UE used for transmitting the PUSCH; and a second entry of the at least two entries corresponds to another antenna panel of the UE.

Clause 12: The method of Clause 1, wherein: the PHR corresponds to multiple serving cells of the one or more serving cells; and the PHR includes multiple entries, each corresponding to one or more of the multiple serving cells.

Clause 13: The method of Clause 12, wherein the information for indicating the antenna panel of the UE comprises a panel identifier (ID) of the antenna panel of the UE to which all of the multiple entries in the PHR correspond.

Clause 14: The method of Clause 12, wherein: the information for indicating the antenna panel of the UE comprises a plurality of panel identifiers (IDs); and each respective panel ID of the plurality of panel IDs is associated with a different entry of the multiple entries in the PHR and specifies the antenna panel of the UE for that different entry.

Clause 15: The method of Clause 12, wherein: the information for indicating an antenna panel of the UE includes a plurality of bits; each bit of the plurality of bits corresponds to a different serving cell of the multiple serving cells; and each bit of the plurality of bits specifies a number of entries of the multiple entries in the PHR that corresponds to its corresponding serving cell of the multiple serving cells.

Clause 16: The method of Clause 15, wherein: the plurality of bits comprises at least a first bit corresponding to a first serving cell of the multiple serving cells; a first value of the first bit indicates that the PHR includes only one entry for the first serving cell and that the antenna panel of the UE corresponding to the one entry comprises an antenna panel of the UE used for transmitting a physical uplink shared channel (PUSCH); and a second value of the first bit indicates that: the PHR includes at least two entries for the first serving cell; a first entry of the at least two entries corresponds to the antenna panel of the UE used for transmitting the PUSCH; and a second entry of the at least two entries corresponds to another antenna panel of the UE.

Clause 17: The method of Clause 12, wherein: the information for indicating an antenna panel of the UE associated with the PHR includes a first plurality of bits and a second plurality of bits; a first bit of the first plurality of bits and a first bit of the second plurality of bits is associated with a first serving cell of the multiple serving cells; and a combination of a value of the first bit of the first plurality of bits and a value of the first bit of the second plurality of bits indicates whether the PHR: includes at least two entries corresponding to the first serving cell; only one entry corresponding to the first serving cell; or no entries corresponding to the first serving cell.

Clause 18: The method of Clause 17, wherein: the combination indicates that the PHR includes the at least two entries corresponding to the first serving cell; and the combination further indicates a different antenna panel of the UE corresponding to each entry of the at least two entries.

Clause 19: The method of any of Clauses 17-18, wherein: the combination indicates the PHR includes only the one entry corresponding to the first serving cell; and the combination further indicates one of a first antenna panel of the UE corresponds to the one entry or a second antenna panel of the UE corresponds to the one entry.

Clause 20: A method for wireless communication by a base station (BS), comprising: receiving a frame including a power headroom report (PHR) with one or more entries, wherein: each of the one or more entries comprises at least: a first field including power headroom information; and a second field including an indication of a maximum permissible exposure (MPE) limit; and the frame includes information for indicating an antenna panel of the UE associated with the PHR; and taking one or more actions based on the PHR.

Clause 21: The method of Clause 20, wherein the PHR corresponds to a single serving cell of one or more serving cells of the UE.

Clause 22: The method of Clause 21, wherein: the PHR includes only one entry corresponding to the single serving cell and the information for indicating the antenna panel of the UE comprises a panel identifier (ID) of the antenna panel of the UE to which the one entry in the PHR corresponds.

Clause 23: The method of Clause 22, wherein the panel ID comprises one or more of: a beam group ID; a transmission configuration indicator (TCI) state pool ID; a sounding reference signal (SRS) resource ID; a control resource set (CORESET) pool ID; or closed loop power control index.

Clause 24: The method of Clause 21, wherein the information for indicating an antenna panel of the UE includes at least one bit specifying a number of entries in the PHR corresponding to the single serving cell.

Clause 25: The method of Clause 24, wherein: a first value of the at least one bit indicates that the PHR includes only one entry corresponding to the single serving cell and that the one entry corresponds to a default antenna panel of the UE; and a second value of the at least one bit indicates that: the PHR includes at least two entries corresponding to the single serving cell; a first entry of the at least two entries correspond to a default antenna panel of the UE; and a second entry of the at least two entries corresponds to another antenna panel of the UE.

Clause 26: The method of Clause 25, wherein the default antenna panel of the UE is an antenna panel of the UE used for transmitting a physical uplink shared channel (PUSCH) media access control element (MAC-CE).

Clause 27: The method of any of Clauses 25-26, wherein the PHR further includes an indication of whether the second entry corresponding to the other antenna panel of the UE includes virtual power headroom information or real power headroom information.

Clause 28: The method of Clause 21, wherein the frame comprises a media access control element (MAC-CE) and the information for indicating the antenna panel of the UE is included in a length field of a subheader of the MAC-CE.

Clause 29: The method of Clause 28, wherein the length field indicates a number of entries in the PHR corresponding to the single serving cell.

Clause 30: The method of Clause 29, wherein: when a value of the length field is less than or equal to a threshold value, the length field indicates that the PHR includes only one entry corresponding to the single serving cell and that the one entry corresponds an antenna panel of the UE used for transmitting a physical uplink shared channel (PUSCH); and when the value of the length field is greater than the threshold value, the length field indicates that: the PHR includes at least two entries corresponding to the single serving cell; a first entry of the at least two entries correspond to the antenna panel of the UE used for transmitting the PUSCH; and a second entry of the at least two entries corresponds to another antenna panel of the UE.

Clause 31: The method of Clause 20, wherein: the PHR corresponds to multiple serving cells of the one or more serving cells; and the PHR includes multiple entries, each corresponding to one or more of the multiple serving cells.

Clause 32: The method of Clause 31, wherein the information for indicating the antenna panel of the UE comprises a panel identifier (ID) of the antenna panel of the UE to which all of the multiple entries in the PHR correspond.

Clause 33: The method of Clause 31, wherein: the information for indicating the antenna panel of the UE comprises a plurality of panel identifiers (IDs); and each respective panel ID of the plurality of panel IDs is associated with a different entry of the multiple entries in the PHR and specifies the antenna panel of the UE for that different entry.

Clause 34: The method of Clause 31, wherein: the information for indicating an antenna panel of the UE includes a plurality of bits; each bit of the plurality of bits corresponds to a different serving cell of the multiple serving cells; and each bit of the plurality of bits specifies a number of entries of the multiple entries in the PHR that corresponds to its corresponding serving cell of the multiple serving cells.

Clause 35: The method of Clause 34, wherein: the plurality of bits comprises at least a first bit corresponding to a first serving cell of the multiple serving cells; when the at least one bit is a first value, the first value indicates that the PHR includes only one entry for the first serving cell and that the antenna panel of the UE corresponding to the one entry comprises an antenna panel of the UE used for transmitting a physical uplink shared channel (PUSCH); and when the at least one bit is a second value, the second value indicates that: the PHR includes at least two entries for the first serving cell; a first entry of the at least two entries corresponds to the antenna panel of the UE used for transmitting the PUSCH; and a second entry of the at least two entries corresponds to another antenna panel of the UE.

Clause 36: The method of Clause 31, wherein: the information for indicating an antenna panel of the UE associated with the PHR includes a first plurality of bits and a second plurality of bits; a first bit of the first plurality of bits and a first bit of the second plurality of bits is associated with a first serving cell of the multiple serving cells; and a combination of a value of the first bit of the first plurality of bits and a value of the first bit of the second plurality of bits indicates whether the PHR: includes at least two entries corresponding to the first serving cell; only one entry corresponding to the first serving cell; or no entries corresponding to the first serving cell.

Clause 37: The method of Clause 36, wherein: the combination indicates that the PHR includes the at least two entries corresponding to the first serving cell; and the combination further indicates a different antenna panel of the UE corresponding to each entry of the at least two entries.

Clause 38: The method of any of Clauses 36-37, wherein: the combination indicates the PHR includes only the one entry corresponding to the first serving cell; and the combination further indicates one of a first antenna panel of the UE corresponds to the one entry or a second antenna panel of the UE corresponds to the one entry.

Clause 39: A processing system, comprising: a memory comprising computer-executable instructions; one or more processors configured to execute the computer-executable instructions and cause the processing system to perform a method in accordance with any one of Clauses 1-38.

Clause 40: A processing system, comprising means for performing a method in accordance with any one of Clauses 1-38.

Clause 41: A non-transitory computer-readable medium comprising computer-executable instructions that, when executed by one or more processors of a processing system, cause the processing system to perform a method in accordance with any one of Clauses 1-38.

Clause 42: A computer program product embodied on a computer-readable storage medium comprising code for performing a method in accordance with any one of Clauses 1-38.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmW), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). Base stations 102 configured for 5G (e.g., 5G NR or Next Generation RAN (NG-RAN)) may interface with core network 190 through second backhaul links 184. Base stations 102 may communicate directly or indirectly (e.g., through the EPC 160 or core network 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communications system 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

Core network 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and core network 190. Generally, AMF 192 provides QoS flow and session management.

All user Internet protocol (IP) packets are transferred through UPF 195, which is connected to the IP Services 197, and which provides UE IP address allocation as well as other functions for core network 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM, etc.) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

Antennas 252, processors 266, 258, 264, and/or controller/processor 280 of UE 104 and/or antennas 234, processors 220, 230, 238, and/or controller/processor 240 of BS 102 may be used to perform the various techniques and methods described herein.

For example, as shown in FIG. 2, the controller/processor 240 of the BS 102 includes a PHR component 241 that may be configured to perform the operations shown in FIG. 7, as well as other operations described herein for antenna-panel-based PHR and MPE reporting. As shown in FIG. 2, the controller/processor 280 of the UE 104 includes a PHR component 281 that may be configured to perform the operations shown in FIG. 6, as well as other operations described herein for antenna-panel-based PHR and MPE reporting. Although shown at the controller/processor, other components of UE 104 and BS 102 may be used to perform the operations described herein.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of antenna-panel-based power headroom (PHR) and maximum permissible exposure (MPE) reporting in communication systems. Changes may be made in the function and arrangement of elements discussed without departing from the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another. In other words, unless a specific order of steps or actions is specified, the order and/or use of specific steps and/or actions may be modified.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

Reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, a digital signal processor (DSP), an application specific integrated circuit (ASIC), or a processor (e.g., a general purpose or specifically programmed processor).

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above can also be considered as examples of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIGS. 6-7.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated herein. Various modifications, changes and variations may be made in the arrangement, operation, and details of the methods and apparatus described herein.

1. A method for wireless communication by a user equipment (UE), comprising:
generating a frame including a power headroom report (PHR) with one or more entries, wherein:
each of the one or more entries comprises at least:
a first field including power headroom information; and
a second field including an indication of a maximum permissible exposure (MPE) limit; and
the frame includes information for indicating an antenna panel of the UE associated with the PHR; and
transmitting the frame to a base station of a serving cell.

2. The method of claim 1, wherein the PHR corresponds to a single serving cell of one or more serving cells of the UE.

3. The method of claim 2, wherein:
the PHR includes only one entry corresponding to the single serving cell; and
the information for indicating the antenna panel of the UE comprises a panel identifier (ID) of the antenna panel of the UE to which the one entry in the PHR corresponds.

4. The method of claim 3, wherein the panel ID comprises one or more of:
a beam group ID;
a transmission configuration indicator (TCI) state pool ID;
a sounding reference signal (SRS) resource ID;
a control resource set (CORESET) pool ID; or
closed loop power control index.

5. The method of claim 2, wherein the information for indicating an antenna panel of the UE includes at least one bit specifying a number of entries in the PHR corresponding to the single serving cell.

6. The method of claim 5, wherein:
when the at least one bit is a first value, the first value indicates that the PHR includes only one entry corresponding to the single serving cell, and that the one entry corresponds to a default antenna panel of the UE; and
when the at least one bit is a second value, the second value indicates that the PHR includes at least two entries corresponding to the single serving cell, a first entry of the at least two entries correspond to a default antenna panel of the UE, and a second entry of the at least two entries corresponds to another antenna panel of the UE.

7. The method of claim 6, wherein the default antenna panel of the UE is an antenna panel of the UE used for transmitting a physical uplink shared channel (PUSCH) media access control element (MAC-CE).

8. The method of claim 6, wherein the PHR further includes an indication of whether the second entry corresponding to the other antenna panel of the UE includes virtual power headroom information or real power headroom information.

9. The method of claim 2, wherein the frame comprises a media access control element (MAC-CE) and the information for indicating the antenna panel of the UE is included in a length field of a subheader of the MAC-CE.

10. The method of claim 9, wherein the length field indicates a number of entries in the PHR corresponding to the single serving cell.

11. The method of claim 10, wherein:
when a value of the length field is less than or equal to a threshold value, the length field indicates that the PHR includes only one entry corresponding to the single serving cell and that the one entry corresponds an antenna panel of the UE used for transmitting a physical uplink shared channel (PUSCH); and
when the value of the length field is greater than the threshold value, the length field indicates that:
the PHR includes at least two entries corresponding to the single serving cell;
a first entry of the at least two entries correspond to the antenna panel of the UE used for transmitting the PUSCH; and
a second entry of the at least two entries corresponds to another antenna panel of the UE.

12. The method of claim 1, wherein:
the PHR corresponds to multiple serving cells of the one or more serving cells; and
the PHR includes multiple entries, each entry corresponding to one or more of the multiple serving cells.

13. The method of claim 12, wherein the information for indicating the antenna panel of the UE comprises a panel identifier (ID) of the antenna panel of the UE to which all of the multiple entries in the PHR correspond.

14. The method of claim 12, wherein:
the information for indicating the antenna panel of the UE comprises a plurality of panel identifiers (IDs); and
each respective panel ID of the plurality of panel IDs is associated with a different entry of the multiple entries in the PHR and specifies the antenna panel of the UE for that different entry.

15. The method of claim 12, wherein:
the information for indicating an antenna panel of the UE includes a plurality of bits;
each bit of the plurality of bits corresponds to a different serving cell of the multiple serving cells; and
each bit of the plurality of bits specifies a number of entries of the multiple entries in the PHR that corresponds to its corresponding serving cell of the multiple serving cells.

16. The method of claim 15, wherein:
the plurality of bits comprises at least a first bit corresponding to a first serving cell of the multiple serving cells;
a first value of the first bit indicates that the PHR includes only one entry for the first serving cell and that the antenna panel of the UE corresponding to the one entry comprises an antenna panel of the UE used for transmitting a physical uplink shared channel (PUSCH); and
a second value of the first bit indicates that:
the PHR includes at least two entries for the first serving cell;
a first entry of the at least two entries corresponds to the antenna panel of the UE used for transmitting the PUSCH; and
a second entry of the at least two entries corresponds to another antenna panel of the UE.

17. The method of claim 12, wherein:
the information for indicating an antenna panel of the UE associated with the PHR includes a first plurality of bits and a second plurality of bits;
a first bit of the first plurality of bits and a first bit of the second plurality of bits is associated with a first serving cell of the multiple serving cells; and
a combination of a value of the first bit of the first plurality of bits and a value of the first bit of the second plurality of bits indicates whether the PHR:
includes at least two entries corresponding to the first serving cell;
only one entry corresponding to the first serving cell; or
no entries corresponding to the first serving cell.

18. The method of claim 17, wherein:
the combination indicates that the PHR includes the at least two entries corresponding to the first serving cell; and
the combination further indicates a different antenna panel of the UE corresponding to each entry of the at least two entries.

19. The method of claim 17, wherein:
the combination indicates the PHR includes only the one entry corresponding to the first serving cell; and
the combination further indicates one of a first antenna panel of the UE corresponds to the one entry or a second antenna panel of the UE corresponds to the one entry.

20. An apparatus for wireless communication by a user equipment (UE), comprising:
a memory comprising computer-executable instructions; and
one or more processors configured to execute the computer-executable instructions and cause the one or more processors to:
generate a frame including a power headroom report (PHR) with one or more entries, wherein:
each of the one or more entries comprises at least:
a first field including power headroom information; and
a second field including an indication of a maximum permissible exposure (MPE) limit; and
the frame includes information for indicating an antenna panel of the UE associated with the PHR; and
transmit the frame to a base station of a serving cell.

21. The apparatus of claim 20, wherein:
the PHR corresponds to a single serving cell of one or more serving cells of the UE;
the PHR includes only one entry corresponding to the single serving cell; and
the information for indicating the antenna panel of the UE comprises a panel identifier (ID) of the antenna panel of the UE to which the one entry in the PHR corresponds.

22. The apparatus of claim 20, wherein:
the PHR corresponds to a single serving cell of one or more serving cells of the UE
the information for indicating an antenna panel of the UE includes at least one bit specifying a number of entries in the PHR corresponding to the single serving cell;
when the at least one bit is a first value, the first value indicates that the PHR includes only one entry corresponding to the single serving cell and that the one entry corresponds to a default antenna panel of the UE; and
when the at least one bit is a second value, the second value indicates that:
the PHR includes at least two entries corresponding to the single serving cell;
a first entry of the at least two entries correspond to a default antenna panel of the UE; and
a second entry of the at least two entries corresponds to another antenna panel of the UE.

23. The apparatus of claim 20, wherein:
the PHR corresponds to a single serving cell of one or more serving cells of the UE;
the frame comprises a media access control element (MAC-CE) and the information for indicating the antenna panel of the UE is included in a length field of a subheader of the MAC-CE;
the length field indicates a number of entries in the PHR corresponding to the single serving cell;
when a value of the length field is less than or equal to a threshold value, the length field indicates that the PHR includes only one entry corresponding to the single serving cell and that the one entry corresponds an antenna panel of the UE used for transmitting a physical uplink shared channel (PUSCH); and
when the value of the length field is greater than the threshold value, the length field indicates that:
the PHR includes at least two entries corresponding to the single serving cell;
a first entry of the at least two entries corresponds to the antenna panel of the UE used for transmitting the PUSCH; and
a second entry of the at least two entries corresponds to another antenna panel of the UE.

24. The apparatus of claim 20, wherein:
the PHR corresponds to multiple serving cells of the one or more serving cells; and
the PHR includes multiple entries, each corresponding to one or more of the multiple serving cells.

25. The apparatus of claim 24, wherein the information for indicating the antenna panel of the UE comprises a panel identifier (ID) of the antenna panel of the UE to which all of the multiple entries in the PHR correspond.

26. The apparatus of claim 24, wherein:
the information for indicating the antenna panel of the UE comprises a plurality of panel identifiers (IDs); and
each respective panel ID of the plurality of panel IDs is associated with a different entry of the multiple entries in the PHR and specifies the antenna panel of the UE for that different entry.

27. The apparatus of claim 24, wherein:
the information for indicating an antenna panel of the UE includes a plurality of bits;
each bit of the plurality of bits corresponds to a different serving cell of the multiple serving cells;
each bit of the plurality of bits specifies a number of entries of the multiple entries in the PHR that corresponds to its corresponding serving cell of the multiple serving cells;
the plurality of bits comprises at least a first bit corresponding to a first serving cell of the multiple serving cells;
a first value of the first bit indicates that the PHR includes only one entry for the first serving cell and that the antenna panel of the UE corresponding to the one entry comprises an antenna panel of the UE used for transmitting a physical uplink shared channel (PUSCH); and
a second value of the first bit indicates that:
the PHR includes at least two entries for the first serving cell;
a first entry of the at least two entries corresponds to the antenna panel of the UE used for transmitting the PUSCH; and
a second entry of the at least two entries corresponds to another antenna panel of the UE.

28. The apparatus of claim 24, wherein:
the information for indicating an antenna panel of the UE associated with the PHR includes a first plurality of bits and a second plurality of bits;
a first bit of the first plurality of bits and a first bit of the second plurality of bits is associated with a first serving cell of the multiple serving cells; and
a combination of a value of the first bit of the first plurality of bits and a value of the first bit of the second plurality of bits indicates whether the PHR:
includes at least two entries corresponding to the first serving cell;
only one entry corresponding to the first serving cell; or
no entries corresponding to the first serving cell.

29. An apparatus for wireless communication by a user equipment (UE), comprising:
means for generating a frame including a power headroom report (PHR) with one or more entries, wherein:
each of the one or more entries comprises at least:
a first field including power headroom information; and
a second field including an indication of a maximum permissible exposure (MPE) limit; and
the frame includes information for indicating an antenna panel of the UE associated with the PHR; and
means for transmitting the frame to a base station of a serving cell.

30. A non-transitory computer-readable medium for wireless communication by a user equipment (UE), comprising computer-executable instructions that, when executed by one or more processors of a processing system, cause the processing system to:
generate a frame including a power headroom report (PHR) with one or more entries, wherein:
each of the one or more entries comprises at least:
a first field including power headroom information; and
a second field including an indication of a maximum permissible exposure (MPE) limit; and
the frame includes information for indicating an antenna panel of the UE associated with the PHR; and
transmit the frame to a base station of a serving cell.
